(19) United States
(12) Patent Application Publication
(10) Pub. No.: US 2025/0220723 A1
(43) Pub. Date: Jul. 3, 2025

(54) METHOD AND APPARATUS FOR INITIATING RANDOM ACCESS FOR AMBIENT IOT IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW); Yu-Hsuan Guo, Taipei City (TW); Ming-Che Li, Taipei City (TW)

(21) Appl. No.: 19/003,948

(22) Filed: Dec. 27, 2024

Related U.S. Application Data
(60) Provisional application No. 63/616,308, filed on Dec. 29, 2023.
(60) Provisional application No. 63/616,389, filed on Dec. 29, 2023.
(60) Provisional application No. 63/616,475, filed on Dec. 29, 2023.
(60) Provisional application No. 63/563,103, filed on Mar. 8, 2024.

(51) Int. Cl. H04W 74/0833

(52) U.S. Cl. CPC H04W 74/0833

(57) ABSTRACT

Methods, systems, and apparatuses are provided for initiating random access for ambient Internet of Things (IoT) in a wireless communication system, wherein a method of a User Equipment (UE) comprises receiving a first signaling of or for triggering a first random access procedure, and determining, in response to receiving the first signaling, whether to trigger the first random access procedure or not based on a first condition, wherein the first condition includes at least one of: whether a timer is running or not, and/or whether a first time duration has elapsed or not.

### CROSS-REFERENCE TO RELATED APPLICATIONS

The present Application claims priority to and the benefit of U.S. Provisional Patent Application Ser. No. 63/616,308, filed Dec. 29, 2023, U.S. Provisional Patent Application Ser. No. 63/616,389, filed Dec. 29, 2023, U.S. Provisional Patent Application Ser. No. 63/616,475, filed Dec. 29, 2023, and U.S. Provisional Patent Application Ser. No. 63/563,103, filed Mar. 8, 2024; with each of the listed and referenced applications and disclosures fully incorporated herein by reference.

### FIELD

This disclosure generally relates to wireless communication networks and, more particularly, to a method and apparatus for initiating random access for ambient Internet of Things (IoT) in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for initiating random access for ambient Internet of Things (IoT) in a wireless communication system. In various embodiments, an ambient IoT User Equipment (UE) initiates a Random Access (RA) procedure under some conditions, e.g. to ensure that the RA procedure could be successfully completed with the applicable UE ability, to reduce power consumption, to reduce signaling overhead, and/or to avoid collisions between multiple ambient IoT UEs. The UE could determine whether to trigger an RA procedure in response to multiple signalings (e.g., corresponding to a same service). In various embodiments, the UE can determine the UE's transmit power properly to achieve reception performance and/or coverage requirement. In various embodiments, ambient IoT UE(s) could access a network and/or transmit Uplink (UL) data using proper resources.

In various embodiments, a method of a UE comprises receiving a first signaling of or for triggering a first random access procedure, and determining, in response to (receiving) the first signaling, whether to trigger the first random access procedure or not based on a first condition, wherein the first condition includes at least one of: whether a timer is running or not, and/or whether a first time duration has elapsed or not.

In various embodiments, a method of a UE comprises receiving a second signaling of or for triggering a second random access procedure, triggering the second random access procedure in response to (receiving) the second signaling, performing a transmission during the second random access procedure, starting a timer and/or a first time duration when one of the following timings occur: receiving the second signaling, triggering the second random access procedure, performing the transmission during the second random access procedure, or the second random access procedure is completed, receiving a first signaling of or for triggering a first random access procedure, and determining, in response to receiving the first signaling, whether to trigger the first random access procedure or not based on a first condition, wherein the first condition includes at least one of: whether the timer is running or not, and/or whether the first time duration has elapsed or not.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.2.1.1-1: Topology 1, from 3GPP TR 38.848 V18.0.0.

FIG. 6 is a reproduction of FIG. 4.2.1.2-1: Topology 2, from 3GPP TR 38.848 V18.0.0.

FIG. 7A is a reproduction of FIG. 9.2.6-1: Random Access Procedures—(a) CBRA with 4-step RA type, from 3GPP TS 38.300 V17.6.0.

FIG. 7B is a reproduction of FIG. 9.2.6-1: Random Access Procedures—(b) CBRA with 2-step RA type, from 3GPP TS 38.300 V17.6.0.

FIG. 7C is a reproduction of FIG. 9.2.6-1: Random Access Procedures—(c) CFRA with 4-step RA type, from 3GPP TS 38.300 V17.6.0.

FIG. 7D is a reproduction of FIG. 9.2.6-1: Random Access Procedures—(d) CFRA with 2-step RA type, from 3GPP TS 38.300 V17.6.0.

FIG. 8 is a reproduction of FIG. 9.2.6-2: Fallback for CBRA with 2-step RA type, from 3GPP TS 38.300 V17.6.0.

FIG. 9 is a diagram showing an example of a UE performing transmissions and receiving signalings in random access procedures, in accordance with embodiments of the present invention.

FIG. 10 is a flow diagram of a method of a UE in a wireless communication system comprising receiving a signaling from a network, determining whether or not to initiate an RA procedure based on a first condition in response to receiving the signaling, and initiating the RA procedure (at least) if or when the first condition is fulfilled, in accordance with embodiments of the present invention.

FIG. 11 is an example table where a power level Pᵢ is the expected/derived/determined UE transmit power, in accordance with embodiments of the present invention.

FIG. 12 is a flow diagram of a method of a UE in a wireless communication system comprising receiving a first signaling of or for triggering a first random access procedure, and determining, in response to receiving the first signaling, whether to trigger the first random access procedure or not based on a first condition, wherein the first condition includes at least one of: whether a timer is running or not, and/or whether a first time duration has elapsed or not, in accordance with embodiments of the present invention.

FIG. 13 is a flow diagram of a method of a UE in a wireless communication system comprising receiving a second signaling of or for triggering a second random access procedure, triggering the second random access procedure in response to receiving the second signaling, performing a transmission during the second random access procedure, starting a timer and/or a first time duration when one of the following timings occur: receiving the second signaling, triggering the second random access procedure, performing the transmission during the second random access procedure, or the second random access procedure is completed, receiving a first signaling of or for triggering a first random access procedure, and determining, in response to receiving the first signaling, whether to trigger the first random access procedure or not based on a first condition, wherein the first condition includes at least one of: whether the timer is running or not, and/or whether the first time duration has elapsed or not, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234058, “Study on solutions for Ambient IoT (Internet of Things) in NR.”; [2] 3GPP TR 38.848 V18.0.0 (2023-09) 3GPP; TSG RAN; Study on Ambient IoT (Internet of Things) in RAN (Release 18); [3] 3GPP TS 38.321 V17.6.0 (2023-09) 3GPP; TSG RAN; NR; MAC protocol specification (Release 17); [4] 3GPP TS 38.300 V17.6.0 (2023-09) 3GPP; TSG RAN; NR; NR and NG-RAN Overall Description (Release 17); [5] 3GPP TS 38.331 V17.6.0 (2023-09) 3GPP; TSG RAN; NR; RRC protocol specification (Release 17); [6] 3GPP TS 38.214 V17.7.0 (2023-09) 3GPP; TSG RAN; NR; Physical layer procedures for data (Release 17); and [7] 3GPP TS 38.213 V17.7.0 (2023-09) 3GPP; TSG RAN; NR; Physical layer procedures for control (Release 17). The standards and documents listed above are hereby expressly and fully incorporated herein by reference in their entirety.

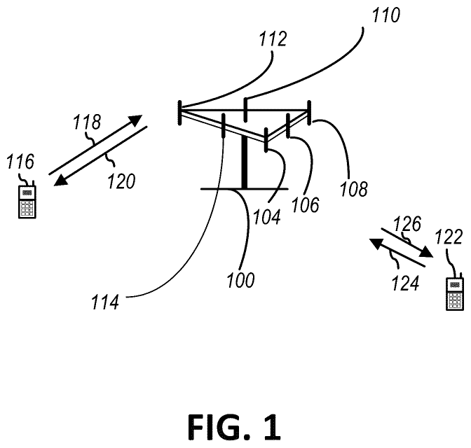

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

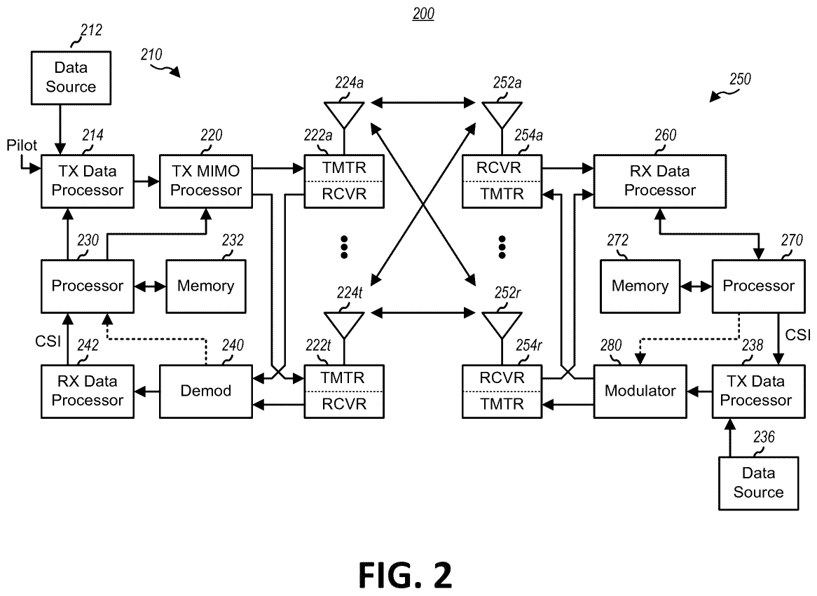

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

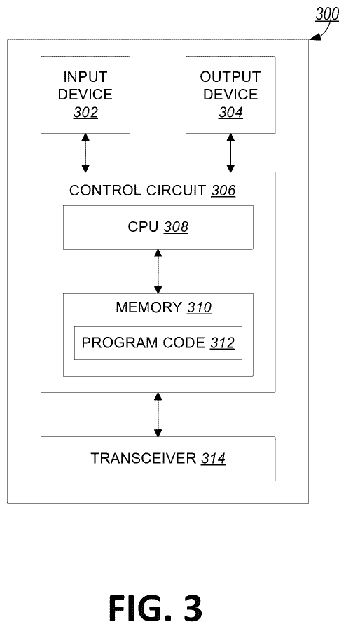

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

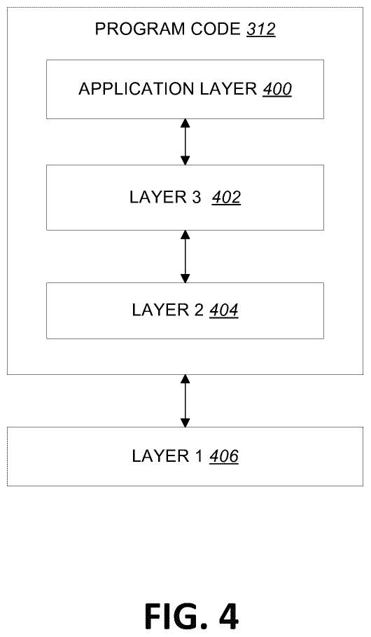

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The study item of ambient Internet of Things (IoT) has been approved in RAN plenary #102 meeting. The description is specified in [1] RP-234058, as below:

### 3 Justification

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by battery that needs to be replaced or recharged manually. The automation and digitalization of various industries open numbers of new markets requiring new IoT technologies of supporting batteryless devices with no energy storage capability or devices with energy storage that do not need to be replaced or recharged manually. The form factor of such devices must be reasonably small to convey the validity of target use cases.

TR 22.840 is being developed by SA1 to capture use cases, traffic scenarios, device constraints of ambient power-enabled Internet of Things and identify new potential service requirements as well as new KPIs. SA1 are considering devices being either battery-less or with limited energy storage capability (i.e., using a capacitor) and the energy is provided through the harvesting of radio waves, light, motion, heat, or any other power source that could be seen suitable.

Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

An example type of application in TR 22.840 is asset identification, which presently has to resort mainly to barcode and RFID in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

TSG RAN has completed a Rel-18 RAN-level SI on Ambient IoT, which provides a terminological and scoping framework for future discussions of Ambient IoT. This has defined representative use cases, deployment scenarios, connectivity topologies, Ambient IoT devices, design targets, and required functionalities; it also conducted a preliminary feasibility assessment, and gave recommendations for down-selection in setting the scope of a further WG-level study.

Since existing technologies cannot meet all the requirements of target use cases, a new IoT technology is recommended to open new markets within 3GPP systems, whose number of connections and/or device density can be orders of magnitude higher than existing 3GPP IoT technologies. The new IoT technology shall provide complexity and power consumption orders of magnitude lower than the existing 3GPP LPWA technologies (e.g. NB-IoT and eMTC), and shall address use cases and scenarios that cannot otherwise be fulfilled based on existing 3GPP LPWA IoT technologies.

### 4 Objective

### 4.1 Objective of SI or Core Part WI or Testing Part WI

This study targets a further assessment at RAN WG-level of Ambient IoT, a new 3GPP IoT technology, suitable for deployment in a 3GPP system, which relies on ultra-low complexity devices with ultra-low power consumption for the very-low end IoT applications. The study shall provide clear differentiation, i.e. addressing use cases and scenarios that cannot otherwise be fulfilled based on existing 3GPP LPWA IoT technology e.g. NB-IoT including with reduced peak Tx power.

### General Scope

The definitions provided in TR 38.848 are taken into this SI, and the following are the exclusive general scope:
A. The overall objective shall be to study a harmonized air interface design with minimized differences (where necessary) for Ambient IoT to enable the following devices:
   i. ˜1 μW peak power consumption, has energy storage, initial sampling frequency offset (SFO) up to 10^{X} ppm, neither DL nor UL amplification in the device. The device's UL transmission is backscattered on a carrier wave provided externally.
   ii. ≤a few hundred μW peak power consumption¹, has energy storage, initial sampling frequency offset (SFO) up to 10^{X} ppm, both DL and/or UL amplification in the device. The device's UL transmission may be generated internally by the device, or be backscattered on a carrier wave provided externally.
   X is to be decided in WGs.
   Coverage design target: Maximum distance of 10-50 m with device indoors as per TR 38.848: “ . . . a range that WGs can sub-select within”.
   For Topologies 1 & 2 (UE as intermediate node under NW control) per TR 38.848, with no RRC states, no mobility (i.e. at least no cell selection/re-selection-like function), no HARQ, no ARQ.
   NOTE 1: It is to be understood that “≤a few hundred μW” means WGs are not tasked with setting a particular value, and that it will be for WG discussions to determine if a presented design with corresponding power consumption satisfies the “≤a few hundred μW” requirement.
B. Deployment Scenarios with the following characteristics, referenced to the tables in Clause 4.2.2 of TR 38.848:
   Deployment scenario 1 with Topology 1
      Basestation and coexistence characteristics: Micro-cell, co-site
   Deployment scenario 2 with Topology 2 and UE as intermediate node, under network control
      Basestation and coexistence characteristics: Macro-cell, co-site
      The location of intermediate node is indoor
C. FR1 licensed spectrum in FDD.
D. Spectrum deployment in-band to NR, in guard-band to LTE/NR, in standalone band(s).
E. Traffic types DO-DTT, DT, with focus on rUC1 (indoor inventory) and rUC4 (indoor command).
   From RAN #104, the study will assess whether the harmonized air interface design (per bullet ‘A’ above) can address the DO-A (Device-originated autonomous) use case, only to identify which part(s) of the harmonized air interface design (per bullet ‘A’ above) is/are not sufficient for the DO-A use case.

Transmission from Ambient IoT device (including backscattering when used) can occur at least in UL spectrum.

The following objectives are set, within the General Scope:
1. Evaluation assumptions
2. Study necessary and feasible solutions for Ambient IoT as prescribed in the General Scope, including decisions on which functions, procedures, etc. are needed and not needed, and ensuring at least the required functionalities in Section 6.2 of TR 38.848.
   RAN1-led:
   For the Ambient IoT DL and UL:
      Frame structure, synchronization and timing, random access
      Numerologies, bandwidths, and multiple access
      Waveforms and modulations
      Channel coding
      Downlink channel/signal aspects
      Uplink channel/signal aspects
      Scheduling and timing relationships
   RAN2-led:
      Study and decide which functions are needed for an Ambient IoT compact protocol stack and lightweight signalling procedure to enable DO-DTT and DT data transmission, and study those functions.
      For example:
         Paging.
         Random access
         Data transmission, including necessary radio resource control aspects, respecting the limitation in the General Scope
         Interactions with upper layers

The description (e.g. regarding topology and assumption) for ambient IoT could be found in TR 38.848 ([2] 3GPP TR 38.848 V18.0.0 (2023-09)):

### 4.2.1 Connectivity Topologies

### 4.2.1.0 Introduction

The following connectivity topologies for Ambient IoT networks and devices are defined for the purposes of the study. In all these topologies, the Ambient IoT device may be provided with a carrier wave from other node(s) either inside or outside the topology. The links in each topology may be bidirectional or unidirectional.

BS, UE, assisting node, or intermediate node could be multiple BSs or UEs, respectively. The mixture of indoor and outdoor placement of such nodes is regarded as a network implementation choice. Account would need to be taken of potential impact on device or node complexity. In the connectivity topologies, this does not imply the existence of multi-hop assisting or intermediate nodes.

### 4.2.1.1 Topology 1: BS↔Ambient IoT Device

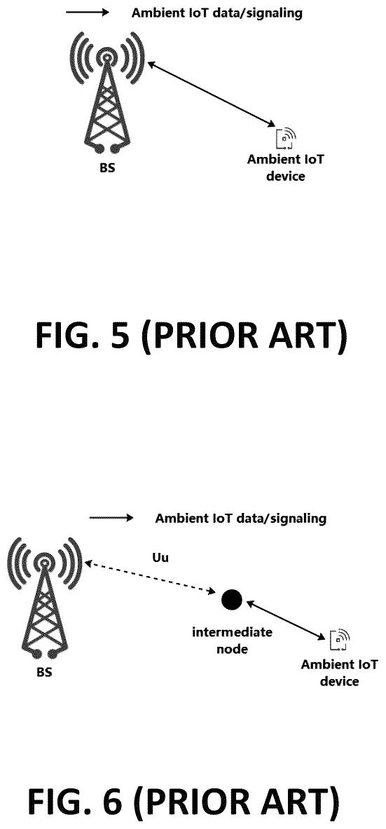

FIG. 5 is a reproduction of FIG. 4.2.1.1-1: Topology 1, from 3GPP TR 38.848 V18.0.0.

In Topology 1, the Ambient IoT device directly and bidirectionally communicates with a basestation. The communication between the basestation and the ambient IoT device includes Ambient IoT data and/or signalling. This topology includes the possibility that the BS transmitting to the Ambient IoT device is a different from the BS receiving from the Ambient IoT device.

### 4.2.1.2 Topology 2: BS↔Intermediate Node↔Ambient IoT Device

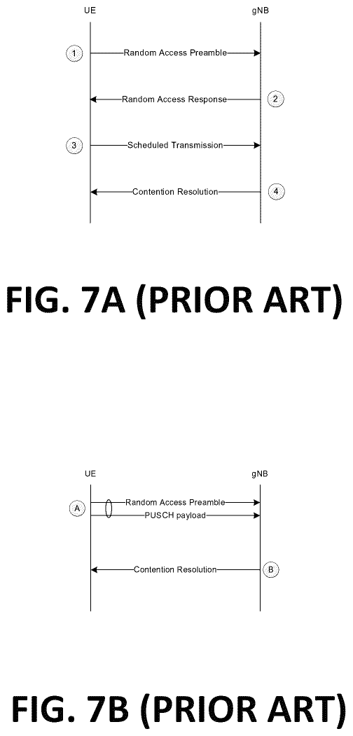

FIG. 6 is a reproduction of FIG. 4.2.1.2-1: Topology 2, from 3GPP TR 38.848 V18.0.0.

In Topology 2, the Ambient IoT device communicates bidirectionally with an intermediate node between the device and basestation. In this topology, the intermediate node can be a relay, IAB node, UE, repeater, etc. which is capable of Ambient IoT. The intermediate node transfers Ambient IoT data and/or signalling between BS and the Ambient IoT device.

### 4.3 Device Categorization

Ambient IoT devices are characterized in the study according to their energy storage capacity, and capability of generating RF signals for their transmissions.

The study considers that a device has either:
No energy storage at all; or
Limited energy storage

Relying on these storage capacities, the study considers the following set of Ambient IoT devices:
Device A: No energy storage, no independent signal generation/amplification, i.e. backscattering transmission.
Device B: Has energy storage, no independent signal generation, i.e. backscattering transmission. Use of stored energy can include amplification for reflected signals.
Device C: Has energy storage, has independent signal generation, i.e., active RF components for transmission.

A limited energy storage can be different among implementations within Device B or implementations within Device C, and different between Device B and Device C. Such storage is expected to be order(s) of magnitude smaller than an NB-IoT device would typically include.

The current random access (RA) procedure is specified in TS 38.321 ([3] 3GPP TS 38.321 V17.6.0 (2023-09)). The (current) RA procedure would be performed by a legacy UE:

### 5.1 Random Access Procedure

### 5.1.1 Random Access Procedure Initialization

The Random Access procedure described in this clause is initiated by a PDCCH order, by the MAC entity itself, or by RRC for the events in accordance with TS 38.300 [2]. There is only one Random Access procedure ongoing at any point in time in a MAC entity. The Random Access procedure on an SCell shall only be initiated by a PDCCH order with ra-PreambleIndex different from 0b000000.

When the Random Access procedure is initiated on a Serving Cell, the MAC entity shall:
1> perform the BWP operation as specified in clause 5.15;
1> select the set of Random Access resources applicable to the current Random Access procedure according to clause 5.1.1b;
1> perform initialization of variables specific to Random Access type as specified in clause 5.1.1a;
1> if RA_TYPE is set to 2-stepRA:
   2> perform the Random Access Resource selection procedure for 2-step RA type (see clause 5.1.2a).
1> else:
   2> perform the Random Access Resource selection procedure (see clause 5.1.2).

### 5.1.1b Selection of the Set of Random Access Resources for the Random Access Procedure

The MAC entity shall:
1> if neither contention-free Random Access Resources nor Random Access Resources for SI request have been provided for this Random Access procedure and one or more of the features including RedCap and/or Slicing and/or SDT and/or MSG3 repetition is applicable for this Random Access procedure:
   2> if none of the sets of Random Access resources are available for any feature applicable to the current Random Access procedure (as specified in clause 5.1.1c):
      3> select the set(s) of Random Access resources that are not associated with any feature indication (as specified in clause 5.1.1c) for this Random Access procedure.
   2> else if there is one set of Random Access resources available which can be used for indicating all features triggering this Random Access procedure:
      3> select this set of Random Access resources for this Random Access procedure.
   2> else (i.e. there are one or more sets of Random Access resources available that are configured with indication(s) for a subset of all features triggering this Random Access procedure):
      3> select a set of Random Access resources from the available set(s) of Random Access resources based on the priority order indicated by upper layers as specified in clause 5.1.1d for this Random Access Procedure.
1> else:
   2> select the set of Random Access resources that are not associated with any feature indication (as specified in clause 5.1.1c) for the current Random Access procedure.

### 5.1.1c Availability of the Set of Random Access Resources

The MAC entity shall for each set of configured Random Access resources for 4-step RA type and for each set of configured Random Access resources for 2-step RA type:
1> if redCap is set to true for a set of Random Access resources:
   2> consider the set of Random Access resources as not available for a Random Access procedure for which RedCap is not applicable.
1> if smallData is set to true for a set of Random Access resources:
   2> consider the set of Random Access resources as not available for the Random Access procedure which is not triggered for RA-SDT.
1> if NSAG-List is configured for a set of Random Access resources:
   2> consider the set of Random Access resources as not available for the Random Access procedure unless it is triggered for any one of the NSAG-ID(s) in the NSAG-List.
1> if msg3-Repetitions is set to true for a set of Random Access resources:
   2> consider the set of Random Access resources as not available for the Random Access procedure if Msg3 repetition is not applicable.
1> if a set of Random Access resources is not configured with FeatureCombination:
   2> consider the set of Random Access resources to not associated with any feature.

### 5.1.2 Random Access Resource Selection

If the selected RA_TYPE is set to 4-stepRA, the MAC entity shall:
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> if the RA_TYPE is switched from 2-stepRA to 4-stepRA:
   2> select a Random Access Preamble randomly with equal probability from the Random Access Preambles associated with the selected SSB and the selected Random Access Preambles group;
   2> set the PREAMBLE_INDEX to the selected Random Access Preamble.
1> else if an SSB is selected above:
   2> determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH (the MAC entity shall select a PRACH occasion randomly with equal probability amongst the consecutive PRACH occasions according to clause 8.1 of TS 38.213 [6] regardless the FR2 UL gap, corresponding to the selected SSB; the MAC entity may take into account the possible occurrence of measurement gaps and MUSIM gaps when determining the next available PRACH occasion corresponding to the selected SSB).
1> perform the Random Access Preamble transmission procedure (see clause 5.1.3).

### 5.1.2a Random Access Resource Selection for 2-Step RA Type

If the selected RA_TYPE is set to 2-stepRA, the MAC entity shall:
1> else (i.e. for the contention-based Random Access Preamble selection):
   2> if at least one of the SSBs with SS-RSRP above msgA-RSRP-ThresholdSSB is available:
      3> select an SSB with SS-RSRP above msgA-RSRP-ThresholdSSB.
   2> else:
      3> select any SSB.
   2> select a Random Access Preamble randomly with equal probability from the 2-step RA type Random Access Preambles associated with the selected SSB and the selected Random Access Preambles group;
   2> set the PREAMBLE_INDEX to the selected Random Access Preamble.
1> determine the next available PRACH occasion from the PRACH occasions corresponding to the selected SSB permitted by the restrictions given by the msgA-SSB-SharedRO-MaskIndex if configured, or ra-ssb-OccasionMaskIndex if configured, or ssb-SharedRO-MaskIndex if configured (the MAC entity shall select a PRACH occasion randomly with equal probability among the consecutive PRACH occasions allocated for 2-step RA type according to clause 8.1 of TS 38.213 [6] regardless the FR2 UL gap, corresponding to the selected SSB; the MAC entity may take into account the possible occurrence of measurement gaps and MUSIM gaps when determining the next available PRACH occasion corresponding to the selected SSB);
1> if the Random Access Preamble was not selected by the MAC entity among the contention-based Random Access Preamble(s):
   2> select a PUSCH occasion from the PUSCH occasions configured in msgA-CFRA-PUSCH corresponding to the PRACH slot of the selected PRACH occasion, according to msgA-PUSCH-Resource-Index corresponding to the selected SSB;
   2> determine the UL grant and the associated HARQ information for the MSGA payload in the selected PUSCH occasion;
   2> deliver the UL grant and the associated HARQ information to the HARQ entity.
1> else:
   2> select a PUSCH occasion corresponding to the selected preamble and PRACH occasion according to clause 8.1A of TS 38.213 [6];
   2> determine the UL grant for the MSGA payload according to the PUSCH configuration associated with the selected Random Access Preambles group and determine the associated HARQ information;
   2> if the selected preamble and PRACH occasion is mapped to a valid PUSCH occasion as specified in clause 8.1A of TS 38.213 [6]:
      3> deliver the UL grant and the associated HARQ information to the HARQ entity.
1> perform the MSGA transmission procedure (see clause 5.1.3a).

### 5.1.3 Random Access Preamble Transmission

The MAC entity shall, for each Random Access Preamble:
1> if PREAMBLE_TRANSMISSION_COUNTER is greater than one; and
1> if the notification of suspending power ramping counter has not been received from lower layers; and
1> if LBT failure indication was not received from lower layers for the last Random Access Preamble transmission; and
1> if SSB or CSI-RS selected is not changed from the selection in the last Random Access Preamble transmission:
   2> increment PREAMBLE_POWER_RAMPING_COUNTER by 1.
1> select the value of DELTA_PREAMBLE according to clause 7.3;
1> set PREAMBLE_RECEIVED_TARGET_POWER to preambleReceivedTargetPower+DELTA_PREAMBLE+ (PREAMBLE_POWER_RAMPING_COUNTER−1)×PREAMBLE_POWER_RAMPING_STEP+POWER_OFFSET_2STEP_RA;
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX, and PREAMBLE_RECEIVED_TARGET_POWER.

### 5.1.3a MSGA Transmission

The MAC entity shall, for each MSGA:
1> if PREAMBLE_TRANSMISSION_COUNTER is greater than one; and
1> if the notification of suspending power ramping counter has not been received from lower layers; and
1> if LBT failure indication was not received from lower layers for the last MSGA Random Access Preamble transmission; and
1> if SSB selected is not changed from the selection in the last Random Access Preamble transmission:
   2> increment PREAMBLE_POWER_RAMPING_COUNTER by 1.
1> select the value of DELTA_PREAMBLE according to clause 7.3;
1> set PREAMBLE_RECEIVED_TARGET_POWER to msgA-PreambleReceivedTargetPower+DELTA_PREAMBLE+(PREAMBLE_POWER_RAMPING_COUNTER−1)×PREAMBLE_POWER_RAMPING_STEP;
1> if this is the first MSGA transmission within this Random Access procedure:
   2> if the transmission is not being made for the CCCH logical channel:
      3> indicate to the Multiplexing and assembly entity to include a C-RNTI MAC CE in the subsequent uplink transmission.
   2> obtain the MAC PDU to transmit from the Multiplexing and assembly entity according to the HARQ information determined for the MSGA payload (see clause 5.1.2a) and store it in the MSGA buffer.
1> compute the MSGB-RNTI associated with the PRACH occasion in which the Random Access Preamble is transmitted;
1> instruct the physical layer to transmit the MSGA using the selected PRACH occasion and the associated PUSCH resource of MSGA (if the selected preamble and PRACH occasion is mapped to a valid PUSCH occasion), using the corresponding RA-RNTI, MSGB-RNTI, PREAMBLE_INDEX, PREAMBLE_RECEIVED_TARGET_POWER, msgA-PreambleReceivedTargetPower, and the amount of power ramping applied to the latest MSGA preamble transmission (i.e. (PREAMBLE_POWER_RAMPING_COUNTER−1)×PREAMBLE_POWER_RAMPING_STEP);
NOTE: The MSGA transmission includes the transmission of the PRACH Preamble as well as the contents of the MSGA buffer in the PUSCH resource corresponding to the selected PRACH occasion and PREAMBLE_INDEX (see TS 38.213 [6])

### 5.1.4 Random Access Response Reception

Once the Random Access Preamble is transmitted and regardless of the possible occurrence of a measurement gap, the MAC entity shall:
3> start the ra-Response Window configured in RACH-ConfigCommon at the first PDCCH occasion as specified in TS 38.213 [6] from the end of the Random Access Preamble transmission.
2> monitor the PDCCH of the SpCell for Random Access Response(s) identified by the RA-RNTI while the ra-Response Window is running.
1> else if a valid (as specified in TS 38.213 [6]) downlink assignment has been received on the PDCCH for the RA-RNTI and the received TB is successfully decoded:
   2> if the Random Access Response contains a MAC subPDU with Random Access Preamble identifier corresponding to the transmitted PREAMBLE_INDEX (see clause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for SI request to upper layers.
      3> else:
         4> if the Random Access Preamble was not selected by the MAC entity among the contention-based Random Access Preamble(s):
         5> consider the Random Access procedure successfully completed.
         4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> obtain the MAC PDU to transmit from the Multiplexing and assembly entity and store it in the Msg3 buffer.

### 5.1.4a MSGB Reception and Contention Resolution for 2-Step RA Type

Once the MSGA preamble is transmitted, regardless of the possible occurrence of a measurement gap, the MAC entity shall:
1> start the msgB-ResponseWindow at the PDCCH occasion as specified in TS 38.213 [6], clause 8.2A;
1> monitor the PDCCH of the SpCell for a Random Access Response identified by MSGB-RNTI while the msgB-ResponseWindow is running;
1> if C-RNTI MAC CE was included in the MSGA:
   2> monitor the PDCCH of the SpCell for Random Access Response identified by the C-RNTI while the msgB-Response Window is running.
1> if notification of a reception of a PDCCH transmission of the SpCell is received from lower layers:
   2> if the C-RNTI MAC CE was included in MSGA:
      3> if the Random Access procedure was initiated for SpCell beam failure recovery or for beam failure recovery of both BFD-RS sets of SpCell (as specified in clause 5.17) and the PDCCH transmission is addressed to the C-RNTI:
         4> consider this Random Access Response reception successful;
         4> stop the msgB-Response Window;
         4> consider this Random Access procedure successfully completed.
         4> if a downlink assignment has been received on the PDCCH for the C-RNTI and the received TB is successfully decoded:
         5> if the MAC PDU contains the Absolute Timing Advance Command MAC CE:
         6> process the received Timing Advance Command (see clause 5.2);
         6> consider this Random Access Response reception successful;
         6> stop the msgB-ResponseWindow;
         6> consider this Random Access procedure successfully completed and finish the disassembly and demultiplexing of the MAC PDU.
   2> if a valid (as specified in TS 38.213 [6]) downlink assignment has been received on the PDCCH for the MSGB-RNTI and the received TB is successfully decoded:
      3> if the MSGB contains a fallbackRAR MAC subPDU; and
      3> if the Random Access Preamble identifier in the MAC subPDU matches the transmitted PREAMBLE_INDEX (see clause 5.1.3a):
         4> consider this Random Access Response reception successful;
         6> if the Msg3 buffer is empty:
         7> obtain the MAC PDU to transmit from the MSGA buffer and store it in the Msg3 buffer;
         6> process the received UL grant value and indicate it to the lower layers and proceed with Msg3 transmission.
NOTE: If within a 2-step RA type procedure, an uplink grant provided in the fallback RAR has a different size than the MSGA payload, the UE behavior is not defined.
   3> else if the MSGB contains a successRAR MAC subPDU; and
   3> if the CCCH SDU was included in the MSGA and the UE Contention Resolution Identity in the MAC subPDU matches the CCCH SDU:
      4> stop msgB-Response Window;
         5> set the C-RNTI to the value received in the successRAR;
      4> consider this Random Access Response reception successful;
      4> consider this Random Access procedure successfully completed;
      4> finish the disassembly and demultiplexing of the MAC PDU.

### 5.1.5 Contention Resolution

Once Msg3 is transmitted the MAC entity shall:
   2> start or restart the ra-ContentionResolutionTimer in the first symbol after the end of the Msg3 transmission.
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.

The general description of RA procedure is specified in TS 38.300 ([4] 3GPP TS 38.300 V17.6.0 (2023-09)):

### 9.2.6 Random Access Procedure

The random access procedure is triggered by a number of events:
Initial access from RRC_IDLE;
SDT in RRC_INACTIVE (see clause 18);

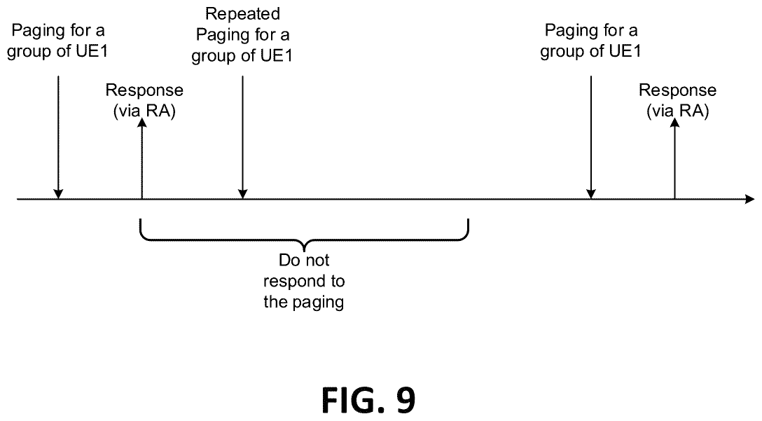

Two types of random access procedure are supported: 4-step RA type with MSG1 and 2-step RA type with MSGA. Both types of RA procedure support contention-based random access (CBRA) and contention-free random access (CFRA) as shown on FIG. 9.2.6-1 below.

The UE selects the type of random access at initiation of the random access procedure based on network configuration:
when CFRA resources are not configured, an RSRP threshold is used by the UE to select between 2-step RA type and 4-step RA type;
when CFRA resources for 4-step RA type are configured, UE performs random access with 4-step RA type;
when CFRA resources for 2-step RA type are configured, UE performs random access with 2-step RA type.

The network does not configure CFRA resources for 4-step and 2-step RA types at the same time for a Bandwidth Part (BWP). CFRA with 2-step RA type is only supported for handover.

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure as shown in FIG. 9.2.6-1 (c). For CBRA, upon reception of the random access response, the UE sends MSG3 using the UL grant scheduled in the response and monitors contention resolution as shown in FIG. 9.2.6-1 (a). If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure as shown in FIG. 9.2.6-1 (d). For CBRA, if contention resolution is successful upon receiving the network response, the UE ends the random access procedure as shown in FIG. 9.2.6-1 (b); while if fallback indication is received in MSGB, the UE performs MSG3 transmission using the UL grant scheduled in the fallback indication and monitors contention resolution as shown in FIG. 9.2.6-2. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

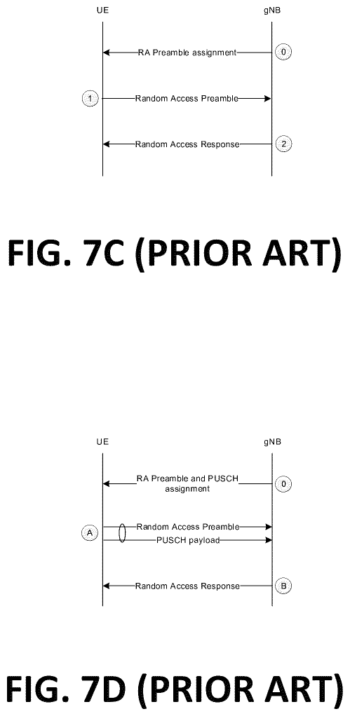

FIG. 7A is a reproduction of FIG. 9.2.6-1: Random Access Procedures—(a) CBRA with 4-step RA type, from 3GPP TS 38.300 V17.6.0.

FIG. 7B is a reproduction of FIG. 9.2.6-1: Random Access Procedures—(b) CBRA with 2-step RA type, from 3GPP TS 38.300 V17.6.0.

FIG. 7C is a reproduction of FIG. 9.2.6-1: Random Access Procedures—(c) CFRA with 4-step RA type, from 3GPP TS 38.300 V17.6.0.

FIG. 7D is a reproduction of FIG. 9.2.6-1: Random Access Procedures—(d) CFRA with 2-step RA type, from 3GPP TS 38.300 V17.6.0.

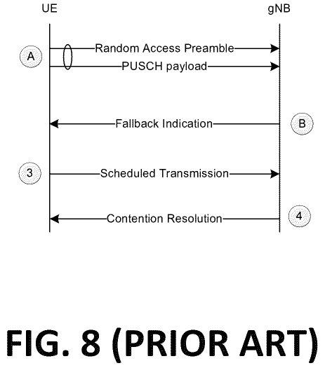

FIG. 8 is a reproduction of FIG. 9.2.6-2: Fallback for CBRA with 2-step RA type, from 3GPP TS 38.300 V17.6.0.

For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

The network can associate a set of RACH resources with feature(s) applicable to a Random Access procedure: Network Slicing (see clause 16.3), RedCap (see clause 16.13), SDT (see clause 18), and NR coverage enhancement (see clause 19). A set of RACH resources associated with a feature is only valid for random access procedures applicable to at least that feature; and a set of RACH resources associated with several features is only valid for random access procedures having at least all of these features. The UE selects the set(s) of applicable RACH resources, after uplink carrier (i.e. NUL or SUL) and BWP selection and before selecting the RA type.

Some configurations related to initial access and random access are specified in TS 38.331 ([5] 3GPP TS 38.331 V17.6.0 (2023-09)):

************************************** Quotation Start [5] **********************************

| | |
|---|---|
| - | Paging |

The Paging message is used for the notification of one or more UEs.

| ... | | | |
|---|---|---|---|
| Direction: Network to UE | | | |
| | Paging message | | |
| Paging ::= | SEQUENCE { | | |
| pagingRecordList | PagingRecordList | | |
| OPTIONAL, -- Need N | | | |
| ... | | | |
| } | | | |
| Paging-v1700-IEs ::= | SEQUENCE { | | |
| pagingRecordList-v1700 | PagingRecordList-v1700 | | |
| OPTIONAL, -- Need N | | | |
| ... | | | |
| } | | | |
| PagingRecordList ::= | SEQUENCE (SIZE(1..maxNrofPageRec)) OF PagingRecord | | |
| PagingRecordList-v1700 ::= | SEQUENCE (SIZE(1..maxNrofPageRec)) OF PagingRecord-v1700 | | |
| ... | | | |
| PagingRecord ::= | SEQUENCE { | | |
| ue-Identity | PagingUE-Identity, | | |
| accessType | ENUMERATED {non3GPP} | OPTIONAL, | -- Need N |
| ... | | | |
| } | | | |
| PagingRecord-v1700 ::= | SEQUENCE { | | |
| pagingCause-r17 | ENUMERATED {voice} | OPTIONAL | -- Need N |

| | |
|---|---|
| } | |
| PagingUE-Identity ::= | CHOICE { |
| ng-5G-S-TMSI | NG-5G-S-TMSI, |
| fullI-RNTI | I-RNTI-Value, |
| ... | |
| } | |

PagingRecord field descriptions

accessType
Indicates whether the Paging message is originated due to the PDU sessions from the non-3GPP access.
pagingCause
Indicates whether the Paging message is originated due to IMS voice. If this field is present, it implies that the
corresponding paging entry is for IMS voice. If upper layers indicate the support of paging cause and if this field is not
present but pagingRecordList-v1700 is present, it implies that the corresponding paging entry is for a service other than
IMS voice. Otherwise, paging cause is undetermined.
************************************** Next Quotation *************************************

### BWP-UplinkCommon

The IE BWP-UplinkCommon is used to configure the common parameters of an uplink BWP. They are “cell specific” and the network ensures the necessary alignment with corresponding parameters of other UEs. The common parameters of the initial bandwidth part of the PCell are also provided via system information. For all other serving cells, the network provides the common parameters via dedicated signalling.

BWP-UplinkCommon information element

| | |
|---|---|
| BWP-UplinkCommon ::= | SEQUENCE { |
| genericParameters | BWP, |
| rach-ConfigCommon | SetupRelease { RACH-ConfigCommon } |
| OPTIONAL, -- Need M | |
| pusch-ConfigCommon | SetupRelease { PUSCH-ConfigCommon } |
| OPTIONAL, -- Need M | |
| ... | |
| msgA-ConfigCommon-r16 | SetupRelease { MsgA-ConfigCommon-r16 } |
| OPTIONAL -- Cond SpCellOnly2 | |
| ... | |
| additionalRACH-ConfigList-r17 | SetupRelease { AdditionalRACH-ConfigList-r17 } |
| OPTIONAL, -- Cond SpCellOnly2 | |
| rsrp-ThresholdMsg3-r17 | RSRP-Range |
| OPTIONAL, -- Need R | |
| numberOfMsg3-RepetitionsList-r17 | SEQUENCE (SIZE (4)) OF NumberOfMsg3-Repetitions-r17 |
| OPTIONAL, -- Cond Msg3Rep | |
| ... | |
| } | |
| AdditionalRACH-ConfigList-r17 ::= | SEQUENCE (SIZE(1..maxAdditionalRACH-r17)) OF AdditionalRACH- |
| Config-r17 | |
| AdditionalRACH-Config-r17 ::= | SEQUENCE { |
| rach-ConfigCommon-r17 | RACH-ConfigCommon |
| OPTIONAL, -- Need R | |
| msgA-ConfigCommon-r17 | MsgA-ConfigCommon-r16 |
| OPTIONAL, -- Need R | |
| ... | |
| } | |
| NumberOfMsg3-Repetitions-r17::= | ENUMERATED {n1, n2, n3, n4, n7, n8, n12, n16} |

BWP-UplinkCommon field descriptions

additionalRACH-ConfigList
List of feature or feature combination-specific RACH configurations, i.e. the RACH configurations configured in addition
to the one configured by rach-ConfigCommon and by msgA-ConfigCommon. The network associates all possible
preambles of an additional RACH configuration to one or more feature(s) or feature combination(s). The network does
not configure this list to have more than 16 entries. If both rach-ConfigCommon and msgA-ConfigCommon are
configured for a specific FeatureCombination, the network always provides them in the same additionalRACH-Config.
msgA-ConfigCommon
Configuration of the cell specific PRACH and PUSCH resource parameters for transmission of MsgA in 2-step random
access type procedure. The NW can configure msgA-ConfigCommon only for UL BWPs if the linked DL BWPs (same
bwp-Id as UL-BWP) are the initial DL BWPs or DL BWPs containing the SSB associated to the initial DL BWP or for
RedCap UEs DL BWPs associated with nonCellDefiningSSB or the RedCap-specific initial downlink BWP.
numberOfMsg3-RepetitionsList
The number of repetitions for PUSCH transmission scheduled by RAR UL grant and DCI format 0_0 with CRC scrambled
by TC-RNTI. This field is only applicable when the UE selects Random Access resources indicating Msg3 repetition in
this BWP. If this field is absent when the set(s) of Random Access resources with MSG3 repetition indication are
configured in the BWP-UplinkCommon, the UE shall apply the values {n1, n2, n3, n4} (see TS 38.214 [19], clause
6.1.2.1).
rach-ConfigCommon
Configuration of cell specific random access parameters which the UE uses for contention based and
contention free random access as well as for contention based beam failure recovery in this BWP. The NW
configures SSB-based RA (and hence RACH-ConfigCommon) only for UL BWPs if the linked DL BWPs (same
bwp-Id as UL-BWP) are the initial DL BWPs or DL BWPs containing the SSB associated to the initial DL BWP or
for RedCap UEs DL BWPs associated with nonCellDefiningSSB or the RedCap-specific initial downlink BWP.
The network configures rach-ConfigCommon, whenever it configures contention free random access (for
reconfiguration with sync or for beam failure recovery). For RedCap-specific initial uplink BWP, rach-
ConfigCommon is always configured when msgA-ConfigCommon is configured in this BWP.
rsrp-ThresholdMsg3
Threshold used by the UE for determining whether to select resources indicating Msg3 repetition in this BWP,
as specified in TS 38.321 [3]. The field is mandatory if both set(s) of Random Access resources with MSG3
repetition indication and set(s) of Random Access resources without MSG3 repetition indication are configured
in the BWP. It is absent otherwise.

### MsgA-ConfigCommon

The IE MsgA-ConfigCommon is used to configure the PRACH and PUSCH resource for transmission of MsgA in 2-step random access type procedure.

| | |
|---|---|
| MsgA-ConfigCommon-r16 ::= | SEQUENCE { |
| rach-ConfigCommonTwoStepRA-r16 | RACH-ConfigCommonTwoStepRA-r16, |
| msgA-PUSCH-Config-r16 | MsgA-PUSCH-Config-r16 |
| OPTIONAL --Cond InitialBWPConfig | |
| } | |
| ... | |

### MsgA-PUSCH-Config

The IE MsgA-PUSCH-Config is used to specify the PUSCH allocation for MsgA in 2-step random access type procedure.

### RACH-ConfigCommon

The IE RACH-ConfigCommon is used to specify the cell specific random-access parameters.

### RACH-ConfigCommonTwoStepRA

The IE RACH-ConfigCommonTwoStepRA is used to specify cell specific 2-step random-access type parameters.

### RACH-ConfigDedicated

The IE RACH-ConfigDedicated is used to specify the dedicated random access parameters.

### RACH-ConfigGeneric

The IE RACH-ConfigGeneric is used to specify the random-access parameters both for regular random access as well as for beam failure recovery.

### RACH-ConfigGenericTwoStepRA

The IE RACH-ConfigGenericTwoStepRA is used to specify the 2-step random access type parameters.

In TS 38.214 ([6] 3GPP TS 38.214 V17.7.0 (2023-09)), the downlink power allocation is specified.

### 4.1 Power Allocation for Downlink

The gNB determines the downlink transmit EPRE.

For the purpose of SS-RSRP, SS-RSRQ and SS-SINR measurements, the UE may assume downlink EPRE is constant across the bandwidth. For the purpose of SS-RSRP, SS-RSRQ and SS-SINR measurements, the UE may assume downlink EPRE is constant over SSS carried in different SS/PBCH blocks. For the purpose of SS-RSRP, SS-RSRQ and SS-SINR measurements, the UE may assume that the ratio of SSS EPRE to PBCH DM-RS EPRE is 0 dB.

For downlink DM-RS associated with PDSCH, the UE may assume the ratio of PDSCH EPRE to DM-RS EPRE (β_{DMRS} [dB]) is given by Table 4.1-1 according to the number of DM-RS CDM groups without data as described in Clause 5.1.6.2.

In TS 38.213 ([7] 3GPP TS 38.213 V17.7.0 (2023-09)), RA procedure and uplink power control are specified:

### 7 Uplink Power Control

Uplink power control determines a power for PUSCH, PUCCH, SRS, and PRACH transmissions.

### 7.1 Physical Uplink Shared Channel

For a PUSCH transmission on active UL BWP b, as described in clause 12, of carrier f of serving cell c, a UE first calculates a linear value \hat{P}_{PUSCH,b,f,c}(i, j, q_{d}, l) of the transmit power P_{PUSCH,b,f,c}(i, j, q_{d}, l), with parameters as defined in clause 7.1.1.

The UE splits the power equally across the antenna ports on which the UE transmits the PUSCH with non-zero power.

### 7.1.1 UE Behaviour

If a UE transmits a PUSCH on active UL BWP b of carrier f of serving cell c using parameter set configuration with index j and PUSCH power control adjustment state with index l, the UE determines the PUSCH transmission power P_{PUSCH,b,f,c}(i, j, q_{d}, l) in PUSCH transmission occasion i as

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ]$$

where,
P_{CMAX,f,c}(i) is the UE configured maximum output power defined in [8-1, TS 38.101-1], [8-2, TS 38.101-2] and [8-3, TS 38.101-3] for carrier f of serving cell c in PUSCH transmission occasion i.
PL_{b,f,c}(q_{d}) is a downlink pathloss estimate in dB calculated by the UE using reference signal (RS) index q_{d} for the active DL BWP, as described in clause 12, of carrier f of serving cell c

### 7.2 Physical Uplink Control Channel

### 7.2.1 UE Behaviour

If a UE transmits a PUCCH on active UL BWP b of carrier f in the primary cell c using PUCCH power control adjustment state with index l, the UE determines the PUCCH transmission power P_{PUCCH,b,f,c}(i, qᵤ, q_{d}, l) in PUCCH transmission occasion i as

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \} [ dBm ]$$

where
P_{CMAX,f,c}(i) is the UE configured maximum output power . . .
PL_{b,f,c}(q_{d}) is a downlink pathloss estimate in dB calculated by the UE using RS resource index q_{d} as described in clause 7.1.1 for the active DL BWP b of carrier f of the primary cell c as described in clause 12

### 7.3 Sounding Reference Signals

For SRS, a UE splits a linear value \hat{P}_{SRS,b,f,c}(i, qₛ, l) of the transmit power P_{SRS,b,f,c}(i, qₛ, l) on active UL BWP b of carrier f of serving cell c equally across the configured antenna ports for SRS.

### 7.3.1 UE Behaviour

If a UE transmits SRS based on a configuration by SRS-ResourceSet on active UL BWP b of carrier f of serving cell c using SRS power control adjustment state with index l, the UE determines the SRS transmission power P_{SRS,b,f,c}(i, qₛ, l) in SRS transmission occasion i as

$${P}_{SRS , b , f , c} ( i , {q}_{s} , l ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix} \} [ dBm ]$$

where,
P_{CMAX,f,c}(i) is the UE configured maximum output power . . .
PL_{b,f,c}(q_{d}) is a downlink pathloss estimate in dB calculated by the UE using RS resource index q_{d} as described in clause 7.1.1 for the active DL BWP of serving cell c and SRS resource set qₛ [6, TS 38.214]. The RS resource index q_{d} is provided by pathlossReferenceRS associated with the SRS resource set qₛ and is either an ssb-Index providing a SS/PBCH block index or a csi-RS-Index providing a CSI-RS resource index. If the UE is provided enablePL-RS-UpdateForPUSCH-SRS, a MAC CE [11, TS 38.321] can provide by SRS-PathlossReferenceRS-Id a corresponding RS resource index q_{d} for aperiodic or semi-persistent SRS resource set

### 7.4 Physical Random Access Channel

A UE determines a transmission power for a physical random access channel (PRACH), P_{PRACH,b,f,c}(i), on active UL BWP b of carrier f of serving cell C based on DL RS for serving cell C in transmission occasion i as

$${P}_{PRACH , b , f , c} ( i ) = min \{ {P}_{CMAX , f , c} ( i ) , {P}_{PRACH , target , f , c} + {PL}_{b , f , c} \} [ dBm ] ,$$

where P_{CMAX,f,c}(i) is the UE configured maximum output power defined in [8-1, TS 38.101-1], [8-2, TS 38.101-2] and [8-3, TS 38.101-3] for carrier f of serving cell C within transmission occasion i, P_{PRACH,target,f,c} is the PRACH target reception power PREAMBLE_RECEIVED_TARGET_POWER provided by higher layers [11, TS 38.321] for the active UL BWP b of carrier f of serving cell C, and PL_{b,f,c} is a pathloss for the active UL BWP b of carrier f based on the DL RS associated with the PRACH transmission on the active DL BWP of serving cell C and calculated by the UE in dB as referenceSignalPower—higher layer filtered RSRP in dBm, where RSRP is defined in [7, TS 38.215] and the higher layer filter configuration is defined in [12, TS 38.331]. If the active DL BWP is the initial DL BWP and for SS/PBCH block and CORESET multiplexing pattern 2 or 3, as described in clause 13, the UE determines PL_{b,f,c} based on the SS/PBCH block associated with the PRACH transmission.

### 8 Random Access Procedure

Prior to initiation of the physical random access procedure, Layer 1 receives from higher layers a set of SS/PBCH block indexes and provides to higher layers a corresponding set of RSRP measurements.

Prior to initiation of the physical random access procedure, Layer 1 may receive from higher layers an indication to perform a Type-1 random access procedure, as described in clauses 8.1 through 8.4, or a Type-2 random access procedure as described in clauses 8.1 through 8.2A.

Prior to initiation of the physical random access procedure, Layer 1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N_{CS}), and set type (unrestricted, restricted set A, or restricted set B)).

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

If a random access procedure is initiated by a PDCCH order to the UE, a PRACH transmission is with a same SCS as a PRACH transmission initiated by higher layers.

If a UE is configured with two UL carriers for a serving cell and the UE detects a PDCCH order, the UE uses the UL/SUL indicator field value from the detected PDCCH order to determine the UL carrier for the corresponding PRACH transmission.

### 8.1 Random Access Preamble

Physical random access procedure is triggered upon request of a PRACH transmission by higher layers or by a PDCCH order. A configuration by higher layers for a PRACH transmission includes the following:
A configuration for PRACH transmission [4, TS 38.211].
A preamble index, a preamble SCS, P_{PRACH,target}, a corresponding RA-RNTI, and a PRACH resource.

A PRACH is transmitted using the selected PRACH format with transmission power P_{PRACH,b,f,c}(i), as described in clause 7.4, on the indicated PRACH resource.

SS/PBCH block indexes provided by ssb-PositionsInBurst in SIB1 or in ServingCellConfigCommon are mapped to valid PRACH occasions in the following order where the parameters are described in [4, TS 38.211].
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

For the indicated preamble index, the ordering of the PRACH occasions is
First, in increasing order of frequency resource indexes for frequency multiplexed PRACH occasions
Second, in increasing order of time resource indexes for time multiplexed PRACH occasions within a PRACH slot
Third, in increasing order of indexes for PRACH slots

### 8.1a PUSCH for Type-2 Random Access Procedure

For a Type-2 random access procedure, a UE transmits a PUSCH, when applicable, after transmitting a PRACH. The UE encodes a transport block provided for the PUSCH transmission using redundancy version number 0. The PUSCH transmission is after the PRACH transmission by at least N symbols where N=2 for μ=0 or μ=1, N=4 for μ=2 or μ=3, N=16 for μ=5, N=32 for μ=6, and u is the SCS configuration for the active UL BWP.

A UE does not transmit a PUSCH in a PUSCH occasion if the PUSCH occasion associated with a DMRS resource is not mapped to a preamble of valid PRACH occasions or if the associated PRACH preamble is not transmitted as described in clause 7.5 or clause 11.1 or clause 15 or clause 17.2. A UE can transmit a PRACH preamble in a valid PRACH occasion if the PRACH preamble is not mapped to a valid PUSCH occasion.

A mapping between one or multiple PRACH preambles and a PUSCH occasion associated with a DMRS resource is per PUSCH configuration provided by MsgA-PUSCH-Resource.

A UE determines time resources and frequency resources for PUSCH occasions in an active UL BWP from msgA-PUSCH-Config or separateMsgA-PUSCH-Config for the active UL BWP. If the active UL BWP is not the initial UL

BWP and msgA-PUSCH-Config or separateMsgA-PUSCH-Config is not provided for the active UL BWP, the UE uses the msgA-PUSCH-Config or separateMsgA-PUSCH-Config provided for the initial UL BWP.

A PUSCH occasion for PUSCH transmission is defined by a frequency resource and a time resource, and is associated with a DMRS resource. The DMRS resources are provided by msgA-DMRS-Config.

Each consecutive number of N_{preamble} preamble indexes from valid PRACH occasions in a PRACH slot
first, in increasing order of preamble indexes within a single PRACH occasion
second, in increasing order of frequency resource indexes for frequency multiplexed PRACH occasions
third, in increasing order of time resource indexes for time multiplexed PRACH occasions within a PRACH slot
   are mapped to a valid PUSCH occasion and the associated DMRS resource
first, in increasing order of frequency resource indexes f_{id} for frequency multiplexed PUSCH occasions
second, in increasing order of DMRS resource indexes within a PUSCH occasion, where a DMRS resource index DMRS_{id} is determined first in an ascending order of a DMRS port index and second in an ascending order of a DMRS sequence index [4, TS 38.211]
third, in increasing order of time resource indexes t_{id} for time multiplexed PUSCH occasions within a PUSCH slot
fourth, in increasing order of indexes for Nₛ PUSCH slots
   where N_{preamble}=ceil(T_{preamble}/T_{PUSCH}), T_{preamble} is a total number of valid PRACH occasions per association pattern period multiplied by the number of preambles per valid PRACH occasion provided by rach-ConfigCommonTwoStepRA, and T_{PUSCH} is a total number of valid PUSCH occasions per PUSCH configuration per association pattern period multiplied by the number of DMRS resource indexes per valid PUSCH occasion provided by msgA-DMRS-Config.

### 8.2 Random Access Response-Type-1 Random Access Procedure

In response to a PRACH transmission, a UE attempts to detect a DCI format 1_0 with CRC scrambled by a corresponding RA-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the PRACH occasion corresponding to the PRACH transmission, where the symbol duration corresponds to the SCS for Type1-PDCCH CSS set as defined in clause 10.1. If N_{TA,adj}^{UE} or N_{TA,adj}^{common}, as defined in [4, TS 38.211], is not zero, the window starts after an additional T_{TA}+k_{mac} msec where T_{TA} is defined in [4, TS 38.211] and k_{mac} is provided by k_{mac} or k_{mac}=0 if k_{mac} is not provided. The length of the window in number of slots, based on the SCS for Type1-PDCCH CSS set, is provided by ra-Response Window.

If the UE detects the DCI format 1_0 with CRC scrambled by the corresponding RA-RNTI and LSBs of a SFN field in the DCI format 1_0, if included and applicable, are same as corresponding LSBs of the SFN where the UE transmitted PRACH, and the UE receives a transport block in a corresponding PDSCH within the window, the UE passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer.

A RAR UL grant schedules a PUSCH transmission from the UE. The contents of the RAR UL grant, starting with the MSB and ending with the LSB, are given in Table 8.2-1.

The TPC command value δ_{msg2,b,f,c} is used for setting the power of the PUSCH transmission, as described in clause 7.1.1, and is interpreted according to Table 8.2-2.

TABLE 8.2-1
Random Access Response Grant Content field size

| RAR grant field | Number of bits |
|---|---|
| Frequency hopping flag | 1 |
| PUSCH frequency resource | 12, for operation with shared spectrum |
| allocation | channel access in FR1 or for FR2-2 when |
| | ChannelAccessMode2-r17 is provided |
| | 14, otherwise |
| PUSCH time resource | 4 |
| allocation | |
| MCS | 4 |
| TPC command for PUSCH | 3 |
| CSI request | 1 |
| ChannelAccess-CPext | 2, for operation with shared spectrum |
| | channel access in FR1 or for FR2-2 when |
| | ChannelAccessMode2-r17 is provided |
| | 0, otherwise |

### 8.2A Random Access Response-Type-2 Random Access Procedure

In response to a transmission of a PRACH and a PUSCH, or to a transmission of only a PRACH if the PRACH preamble is mapped to a valid PUSCH occasion, a UE attempts to detect a DCI format 1_0 with CRC scrambled by a corresponding MsgB-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the PUSCH occasion corresponding to the PRACH transmission, where the symbol duration corresponds to the SCS for Type1-PDCCH CSS set. If N_{TA,adj}^{UE} or N_{TA,adj}^{common}, as defined in [4, TS 38.211], is not zero, the window starts after an additional T_{TA}+k_{mac} msec where T_{TA} is defined in [4, TS 38.211] and k_{mac} is provided by k_{mac} or k_{mac}=0 if k_{mac} is not provided. The length of the window in number of slots, based on the SCS for Type1-PDCCH CSS set, is provided by msgB-ResponseWindow.

In response to a transmission of a PRACH, if the PRACH preamble is not mapped to a valid PUSCH occasion, a UE attempts to detect a DCI format 1_0 with CRC scrambled by a corresponding MsgB-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the PRACH occasion corresponding to the PRACH transmission, where the symbol duration corresponds to the SCS for Type1-PDCCH CSS set. The length of the window in number of slots, based on the SCS for Type1-PDCCH CSS set, is provided by msgB-ResponseWindow.

If the UE detects the DCI format 1_0, with CRC scrambled by the corresponding MsgB-RNTI and LSBs of a SFN field in the DCI format 1_0, if applicable, are same as corresponding LSBs of the SFN where the UE transmitted PRACH, and the UE receives a transport block in a corresponding PDSCH within the window, the UE passes the transport block to higher layers. The higher layers indicate to the physical layer
an uplink grant if the RAR message(s) is for fallbackRAR and a random access preamble identity (RAPID) associated with the PRACH transmission is identified, and the UE procedure continues as described in clauses 8.2, 8.3, and 8.4 when the UE detects a RAR UL grant, or
transmission of a PUCCH with HARQ-ACK information having ACK value if the RAR message(s) is for successRAR, where
a PUCCH resource for the transmission of the PUCCH is indicated by PUCCH resource indicator field of 4 bits in the successRAR from a PUCCH resource set that is provided by pucch-ResourceCommon

If the UE detects the DCI format 1_0 with CRC scrambled by a C-RNTI and a transport block in a corresponding PDSCH within the window, the UE transmits a PUCCH with HARQ-ACK information having ACK value if the UE correctly detects the transport block or NACK value if the UE incorrectly detects the transport block and the time alignment timer is running [11, TS 38.321].

If the UE detects a DCI format 1_0 with CRC scrambled by the corresponding MsgB-RNTI and receives a transport block within the window in a corresponding PDSCH, the UE may assume same DM-RS antenna port quasi co-location properties, as described in [6, TS 38.214], as for a SS/PBCH block the UE used for PRACH association, as described in clause 8.1, regardless of whether or not the UE is provided TCI-State for the CORESET where the UE receives the PDCCH with the DCI format 1_0.

### 8.3 PUSCH Scheduled by RAR UL Grant

The frequency domain resource allocation is by uplink resource allocation type 1 [6, TS 38.214]. For an initial UL BWP size of N_{BWP}^{size} RBs, a UE processes the frequency domain resource assignment field as follows

A UE transmits a transport block in a PUSCH scheduled by a RAR UL grant in a corresponding RAR message using redundancy version number 0, if the PUSCH transmission is without repetitions. If a TC-RNTI is provided by higher layers, the scrambling initialization of the PUSCH corresponding to the RAR UL grant in clause 8.2 is by TC-RNTI. Otherwise, the scrambling initialization of the PUSCH corresponding to the RAR UL grant in clause 8.2 is by C-RNTI.

Msg3 PUSCH retransmissions, if any, of the transport block, are scheduled by a DCI format 0_0 with CRC scrambled by a TC-RNTI provided in the corresponding RAR message [11, TS 38.321].

8.4 PDSCH with UE Contention Resolution Identity

In response to a PUSCH transmission scheduled by a RAR UL grant when a UE has not been provided a C-RNTI, the UE attempts to detect a DCI format 1_0 with CRC scrambled by a corresponding TC-RNTI scheduling a PDSCH that includes a UE contention resolution identity [11, TS 38.321]. In response to the PDSCH reception with the UE contention resolution identity, the UE transmits HARQ-ACK information in a PUCCH. The PUCCH transmission is within a same active UL BWP as the PUSCH transmission. A minimum time between the last symbol of the PDSCH reception and the first symbol of the corresponding PUCCH transmission with the HARQ-ACK information is equal to N_{T,1}+0.5 msec. N_{T,1} is a time duration of N₁ symbols corresponding to a PDSCH processing time for UE processing capability 1 when additional PDSCH DM-RS is configured. For μ=0, the UE assumes N_{1,0}=14 [6, TS 38.214].

When detecting a DCI format in response to a PUSCH transmission scheduled by a RAR UL grant, as described in [11, TS 38.321], or corresponding PUSCH retransmission scheduled by a DCI format 0_0 with CRC scrambled by a TC-RNTI provided in the corresponding RAR message [11, TS 38.321], the UE may assume the PDCCH carrying the DCI format has the same DM-RS antenna port quasi co-location properties, as described in [6, TS 38.214], as for a SS/PBCH block the UE used for PRACH association, as described in clause 8.1, regardless of whether or not the UE is provided TCI-State for the CORESET where the UE receives the PDCCH with the DCI format.

The following table of abbreviations is provided for portions of the disclosure below:
D2R: (Ambient Internet of Things (A-IoT)) Device to Reader;
PDRCH: Physical (Ambient IoT) Device (to) Reader Channel;
PRDCH: Physical Reader (to Ambient IoT) Device Channel; and
R2D: Reader to (Ambient IoT) Device.

In the 3GPP RAN1 #116 meeting, there are some agreements on Ambient IoT.

For the purposes of the study, RAN1 uses the following terminologies:
Device 1: ˜1 μW peak power consumption, has energy storage, initial Sampling Frequency Offset (SFO) up to 10^{X} ppm, neither Downlink (DL) nor Uplink (UL) amplification in the device. The device's UL transmission is backscattered on a carrier wave provided externally.
Device 2a: ≤a few hundred u W peak power consumption, has energy storage, initial SFO up to 10^{X} ppm, both DL and/or UL amplification in the device. The device's UL transmission is backscattered on a carrier wave provided externally.
Device 2b: ≤a few hundred u W peak power consumption, has energy storage, initial SFO up to 10^{X} ppm, both DL and/or UL amplification in the device. The device's UL transmission is generated internally by the device.

From the RAN1 perspective, at least when a response is expected from multiple devices that are intended to be identified, an A-IoT contention-based access procedure initiated by the reader is used.

For A-IoT contention-based access procedures, at least slotted-ALOHA based access is studied.

For ambient IoT devices, a dedicated physical broadcast channel for R2D, e.g. Physical Broadcast Channel (PBCH)-like, is not considered for study.

For ambient IoT devices, at least for R2D data transmission, a physical channel (PRDCH) is studied:
System information (if defined) is transmitted on the PRDCH.
FFS Whether/how control information is transmitted on the PRDCH.
Note: the naming of PRDCH is used for the sake of the study.

For ambient IoT devices, at least for D2R data transmission, a physical channel (PDRCH) is studied along with the following:
Response transmitted from the device to reader during an contention-based access procedure is transmitted on the PDRCH.
   FFS: Details of response.
FFS (for further study) Whether/how/what D2R control information (if defined) is transmitted on the PDRCH.
Note: the naming of PDRCH is used for the sake of the study.

In recent years, more devices are expected to be interconnected in the wireless communication world for improving productivity, efficiency, and increasing comforts of life. However, powering all the IoT devices by battery that needs to be replaced or recharged manually would lead to high maintenance cost, environmental issues, and safety hazards for some use cases, e.g., wireless sensors in electrical power. Further reduction of size, complexity, and power consumption of IoT devices can enable the deployment for various applications (e.g., automated manufacturing, smart home).

On the other hand, barcode and Radio Frequency Identification (RFID) have limited the reading range of a few meters which usually requires handheld scanning. It would lead to labor intensive and time-consuming operations. Also, the lack of an interference management scheme would result in severe interference between RFID readers and capacity problems, especially in the case of dense deployment. It is hard to support a large-scale network with seamless coverage for RFID. In contrast, study of ambient IoT investigates the feasibility of a new IoT technology within 3rd Generation Partnership Project (3GPP) systems.

An ambient IoT device/User Equipment (UE) would have ultra-low complexity, very small device size and a long life cycle. The ambient IoT device/UE would have complexity and power consumption orders of magnitude lower than the existing 3GPP Low Power Wide Area (LPWA) technologies (e.g., Narrowband (NB)-IoT, enhanced Machine-Type Communication (eMTC)). The ambient IoT device/UE may not have energy storage or may have energy storage. The energy of ambient IoT device/UE may be provided through the harvesting of radio waves, light, motion, heat, or any other power source that could be suitable. The energy and/or power source may be provided one-shot (e.g., unexpected or aperiodically), periodically or continuously. In one embodiment, the power/energy of the Ambient IoT device/UE may be provided from a carrier wave from the network and/or an intermediate node. In Topology 1, the Ambient IoT device/UE would directly and bidirectionally communicate with a base station. In Topology 2, the Ambient IoT device/UE would communicate bidirectionally with an intermediate node (e.g., a UE or a relay node) between the Ambient IoT device/UE and the base station. The UL transmission of the ambient IoT device/UE may be generated internally by the device/UE, or be backscattered on the carrier wave provided externally. More details regarding the ambient IoT (device/UE) could be found in the study item [1] RP-234058 and [2] 3GPP TR 38.848 V18.0.0.

To enable data and/or signaling transmission, an (ambient IoT) UE would trigger a Random Access (RA) procedure and/or initial access to the network. For example, the (ambient IoT) UE would receive a signaling from a Network (NW). In response to receiving the signaling, the (ambient IoT) UE would trigger an RA procedure.

The signaling may be used to trigger (or indicate) an RA procedure (or initial access) of the UE. The signaling may be used to trigger (or indicate) a transmission (or reception) of the UE. The transmission from the UE may be (or include) a backscattering transmission (or reception) or may be generated internally by the UE. The signaling may be used to provide power source and/or energy to the UE. The signaling may be (or include) any of Radio Resource Control (RRC) signaling (e.g., RRC configuration message), Medium Access Control (MAC) signaling (e.g., MAC Control Element (CE)), or Physical Layer (PHY) signaling (e.g., Physical Downlink Control Channel (PDCCH), Downlink Control Information (DCI)). The signaling may be (or include) a carrier wave (signal) and/or an interrogation signal.

The signaling may be a common signaling or a dedicated signaling. The common signaling may be (or include) a cell-specific configuration. The common signaling may be (or include) a configuration common for multiple UEs, a group of UEs, and/or a UE group. The common signaling may be (or include) a broadcast signaling, system information, and/or paging. The dedicated signaling may be (or include) a UE-specific configuration. The dedicated signaling may be (or include) a configuration dedicated for a (single) UE. The dedicated signaling may be (or include) RRC signaling (e.g., RRC configuration message). The dedicated signaling may be (or include) MAC signaling (e.g., MAC CE). The dedicated signaling may be (or include) PHY signaling (e.g., PDCCH, DCI).

Due to characteristics of ambient IoT such as ultra-low complexity and ultra-low power consumption, it would not always be suitable for an ambient IoT UE to initiate an RA procedure, e.g., in response to receiving the signaling. The ambient IoT UE should check its ability to initiate an RA procedure, e.g., in response to receiving the signaling. Moreover, to reduce power consumption, enhancements on RA should be pursued to avoid collision between multiple ambient IoT UEs.

It is assumed that the network would transmit a signaling (e.g., paging) to multiple UEs for a service request (e.g., inventory, command). The UE would trigger an RA procedure in response to receiving the signaling from the network. Since the signaling is transmitted to multiple UEs and some of the UEs may not respond to the signaling successfully (e.g., missing of the signaling or failure of performing the RA at the first time), the network should ensure that every UE responds successfully by repeating the signaling several times. However, the consequence is that the UE who has already completed an RA procedure may still receive the signaling. In this case, the UE should not trigger the RA again.

To solve the issue, the UE may determine whether or when to initiate (or trigger, perform) an RA procedure in response to or after receiving an NW signaling. The NW signaling may be a signaling described above. The UE may determine whether or when to initiate (or trigger, perform) an RA procedure based on a first condition(s).

The UE may check the first condition(s) in response to (or if, when, after) receiving the NW signaling. If the first condition(s) is fulfilled (at least), the UE may initiate, trigger, perform, continue, and/or resume an RA procedure. If the first condition(s) is not fulfilled (at least), the UE may not initiate, trigger, and/or continue an RA procedure. If the first condition(s) is not fulfilled (at least), the UE may stop, cancel, and/or suspend an RA procedure.

The UE may initiate, trigger, perform, continue, and/or resume an RA procedure, if the first condition(s) is fulfilled (at least), after or in response to receiving the signaling. The UE may not initiate, trigger, and/or continue an RA procedure, if the first condition(s) is not fulfilled (at least), after or in response to receiving the signaling. The UE may not initiate, trigger, continue, and/or resume an RA procedure until the first condition(s) is fulfilled, after or in response to receiving the signaling. The UE may stop, cancel, and/or suspend an RA procedure, if the first condition(s) is not fulfilled (at least), after or in response to receiving the signaling. After or when the UE receives the NW signaling, the UE may check whether the first condition(s) is fulfilled or not. The UE may initiate an RA procedure once or after (at least) the first condition(s) is fulfilled. In response to (or if, when, after) receiving the NW signaling, the UE may initiate, trigger, continue, and/or resume an RA procedure once (at least) the first condition(s) is fulfilled.

Alternatively and/or additionally, the UE may initiate, trigger, continue, and/or resume an RA procedure in response to (or if, when, after) receiving the NW signaling. The NW signaling may be a signaling described above. The UE may determine whether or when to perform an RA resource selection procedure (or RA preamble transmission procedure or MSGA transmission procedure) of the RA procedure based on a first condition(s).

The UE may check the first condition(s) when an RA procedure is pending. The RA procedure is pending when, upon or after the UE receives the NW signaling and/or the RA procedure is triggered (e.g., by upper layer). The RA procedure is pending when, upon or after the RA procedure is suspended. If the first condition(s) is fulfilled (at least), the UE may perform the RA resource selection procedure (or RA preamble transmission procedure or MSGA transmission procedure) of the RA procedure. If the first condition(s) is not fulfilled, the UE may not perform the RA resource selection procedure (or RA preamble transmission procedure or MSGA transmission procedure) of the RA procedure.

The UE may check the first condition(s) in response to initiating, triggering, continuing, and/or resuming the RA procedure. If the first condition(s) is fulfilled (at least), the UE may perform the RA resource selection procedure (or RA preamble transmission procedure or MSGA transmission procedure) of the RA procedure. If the first condition(s) is not fulfilled (at least), the UE may not perform the RA resource selection procedure (or RA preamble transmission procedure or MSGA transmission procedure) of the RA procedure. If the first condition(s) is not fulfilled (at least), the UE may delay and/or suspend the RA procedure.

The UE may perform an RA resource selection procedure (or RA preamble transmission procedure or MSGA transmission procedure) of the RA procedure, if the first condition(s) is fulfilled (at least) upon or in response to initiating, triggering, continuing, and/or resuming the RA procedure. The UE may not perform RA resource selection procedure (or RA preamble transmission procedure or MSGA transmission procedure) of the RA procedure, if the first condition(s) is not fulfilled (at least) upon or in response to initiating, triggering, continuing, and/or resuming the RA procedure. The UE may not perform RA resource selection procedure (or RA preamble transmission procedure or MSGA transmission procedure) of the RA procedure until the first condition(s) is fulfilled, after or in response to initiating, triggering, continuing, and/or resuming the RA procedure. The UE may delay and/or suspend the RA procedure, if the first condition(s) is not fulfilled (at least) upon or in response to initiating, triggering, continuing, and/or resuming the RA procedure. After or when the UE receives the NW signaling and initiates, triggers, continues, and/or resumes an RA procedure, the first condition(s) may not be fulfilled. The UE may perform RA resource selection procedure (or RA preamble transmission procedure or MSGA transmission procedure) of the RA procedure once or after the first condition(s) is fulfilled. In response to (or if, when, after) initiating, triggering, continuing, and/or resuming the RA procedure, the UE may perform RA resource selection procedure (or RA preamble transmission procedure or MSGA transmission procedure) of the RA procedure once the first condition(s) is fulfilled.

The first condition(s) used to determine whether or when to initiate (or trigger, perform) an RA procedure and the first condition(s) used to determine whether or when to perform RA resource selection procedure (or RA preamble transmission procedure or MSGA transmission procedure) of the RA procedure may be the same. Alternatively, the first condition(s) used to determine whether or when to initiate (or trigger, perform) an RA procedure and the first condition(s) used to determine whether or when to perform RA resource selection procedure (or RA preamble transmission procedure or MSGA transmission procedure) of the RA procedure may be (partially or completely) different.

One or more of a first condition(s) may be applied by a first UE and may not be applied by a second UE, e.g., based on the first factor. A first UE and a second UE may have different configurations and/or values for the (one or more of) first condition(s). The first UE and the second UE may be different UEs, e.g., differentiated by the first factor. The first UE and the second UE may be ambient IoT UEs. The UE may determine whether to use the (one or more of) first condition(s) based on the first factor. The UE may determine to use which value of the (one or more of) first condition(s) based on the first factor.

Throughout the present disclosure, the RA resource selection procedure may be referred to the very first or 1^{st} time or first step of the RA resource selection procedure.

The first condition(s) may be one or a combination of the following:

### Power Level

The first condition(s) may include that the power level is fulfilled, e.g., a threshold of the power level is fulfilled. For example, the first condition is fulfilled if (at least) the condition of power level is fulfilled. The power level may comprise any one or more of the following embodiments. There may be one or more thresholds for (determining whether) a power level (is fulfilled). The power level may be determined by threshold(s). The threshold(s) for power level may be configured by the network or be derived by the UE. The threshold(s) for the power level may be determined based on the following embodiments and/or a (selected) RA resources/configuration. The threshold(s) for power level may be indicated or configured by the NW. Alternatively, the threshold(s) for a power level may be determined by the UE. Alternatively, the threshold(s) for a power level may be fixed.

The threshold(s) may be derived based on a peak Transmission (TX) power of the UE. Alternatively and/or additionally, the threshold(s) may be derived based on a repetition number of a transmission (e.g., Msg1, preamble, MSGA, Msg3, or an UL transmission of the RA procedure) to be transmitted by the UE. Alternatively and/or additionally, the threshold(s) may be derived based on the first factor.

In one embodiment, the power level may be a received power of a signal/channel transmitted from the network. The power level may be a received power of a carrier-wave (signal) transmitted from the network. For an instance, the first condition may include the received power is equal to or larger than a threshold.

In one embodiment, the power level may be a (downlink) pathloss derived/determined based on at least the received power of the signal/channel transmitted from the network. The power level may be a (downlink) pathloss derived/determined based on at least the received power of the carrier-wave (signal) transmitted from the network. For an instance, the first condition may include the pathloss is equal to or smaller than a threshold.

In one embodiment, the power level may be an expected/derived/determined UE transmit power for backscattering transmission (e.g., the first transmission and/or the third transmission). For an instance, the first condition may include the expected/derived/determined UE transmit power is equal to or larger than a threshold.

In one embodiment, the power level may be an expected/derived/determined UE transmit power for UL transmission generated internally by the UE (e.g., the first transmission and/or the third transmission). For an instance, the first condition may include the expected/derived/determined UE transmit power is equal to or larger than a threshold.

In one embodiment, the power level may be a maximum UE transmit power (e.g., for the first transmission and/or the third transmission). For an instance, the first condition may include the maximum UE transmit power is equal to or larger than a threshold. Alternatively, the first condition may include the maximum UE transmit power is equal to or smaller than a threshold.

In one embodiment, the power level may be the amount of a UE's battery power/stored power/available power. The UE may estimate/determine/derive how much the battery power/stored power/available power are utilizable/available for performing a (corresponding) RA procedure. For an instance, the first condition may include the amount of the UE's battery power/stored power/available power is equal to or larger than a threshold.

In one embodiment, the power level may be a predefined/(pre-)configured/indicated power. The indicated power can be indicated by the network or by the higher layer of the UE. Preferably in certain embodiments, the predefined/(pre-)configured/indicated power can be a guaranteed or required power (amount or capacity) for enabling/activating/starting a (corresponding) RA procedure. Preferably in certain embodiments, the predefined/(pre-)configured/indicated power can be an expected/estimated power consumption (amount) for completing a (corresponding) RA procedure. For an instance, the first condition may include the UE transmit power is equal to or larger than the predefined/(pre-)configured/indicated power. For an instance, the first condition may include a value is equal to or larger than the predefined/(pre-)configured/indicated power. The value may be derived/determined based on the expected/derived/determined/maximum UE transmit power and the repetition number, e.g., a value of “the expected/derived/determined/maximum UE transmit power” times/multiplying “the repetition number”.

In one embodiment, the power level may be a power difference between the (downlink) pathloss and the expected/derived/determined/maximum UE transmit power. The (downlink) pathloss may be derived/determined based on at least received power of the signal/channel, e.g., a carrier wave (signal), from the network. The expected/derived/determined UE transmit power may be for backscattering transmission or for UL transmission generated internally by the UE. For an instance, the first condition may include the power difference is equal to or smaller than a threshold or a value. The value may be derived/determined based on the expected/derived/determined/maximum UE transmit power and the repetition number, e.g., a value of “the expected/derived/determined/maximum UE transmit power” times/multiplying “the repetition number”.

In one embodiment, the power level may be a power difference between the battery power/stored power/available power and the expected/derived/determined/maximum UE transmit power. The expected/derived/determined UE transmit power may be for backscattering transmission or for UL transmission generated internally by the UE. The UE may estimate/determine/derive how much the battery power/stored power/available power are utilizable for performing the (corresponding) RA procedure. For an instance, the first condition may include the power difference is equal to or larger than a threshold or a value. The value may be derived/determined based on the expected/derived/determined/maximum UE transmit power and the repetition number, e.g., a value of “the expected/derived/determined/maximum UE transmit power” times/multiplying “the repetition number”.

In one embodiment, the power level may be a power difference between a predefined/(pre-)configured/indicated power and the expected/derived/determined/maximum UE transmit power. The indicated power can be indicated by the network or by the higher layer of the UE. Preferably in certain embodiments, the predefined/(pre-)configured/indicated power can be a guaranteed or required power (amount or capacity) for enabling/activating/starting the (corresponding) RA procedure. Preferably in certain embodiments, the predefined/(pre-)configured/indicated power can be an expected/estimated power consumption (amount) for completing the (corresponding) RA procedure. The expected/derived/determined UE transmit power may be for backscattering transmission or for UL transmission generated internally by the UE. For an instance, the first condition may include the power difference is equal to or smaller than a threshold or a value. The value may be derived/determined based on the expected/derived/determined/maximum UE transmit power and the repetition number, e.g., a value of “the expected/derived/determined/maximum UE transmit power” times/multiplying “the repetition number”.

### UE Group

The first condition(s) may include that an information related to the UE's UE group (ID) or the UE's ID is received or indicated in the NW signal (as described above). The information may be (a part of) the UE's UE group (ID) or the UE's ID. For example, the first condition is fulfilled (at least) if the UE's UE group (ID) is received or indicated in the NW signal (as described above). The first condition is fulfilled (at least) if the UE's UE group (ID) is fulfilled by a formula. The formula is pre-defined or (pre-)configured by the NW or the UE. The UE may determine the UE's UE group (ID) based on the first factor.

There may be multiple UE groups for ambient IoT. A UE may be assigned or associated with a UE group. The UE may be predefined or (pre-)configured (e.g., by the UE) with the UE group. The UE may be configured or indicated (e.g., by the NW) with the UE group. The UE may receive a group ID and/or a value to derive/determine the group ID via paging, System Information Block (SIB), and/or PDCCH.

The multiple UEs may be assigned to different UE groups based on the UE types. The UEs with the same UE type may be in a same UE group. The UEs with the same UE type may be in different UE groups. A UE group may comprise UEs with the same or different UE type.

The multiple UEs may be assigned to or associated with different UE groups based on the UE ID. For example, a UE may be assigned to or associated with a UE group, wherein the UE group ID of the UE group may be decided/derived/determined based on at least the UE ID of the UE and a value. Preferably in certain embodiments, the UE group ID of the UE may be decided/derived/determined by the UE ID mod the value. The value may be the number of UE groups. The value may be provided by the NW or be pre-defined or be (pre-)configured. The UE group ID of the UE may be decided by a formula using the UE ID.

The multiple UEs may be assigned to different UE groups based on location. Preferably in certain embodiments, the UEs in a same location and/or same position range may be distributed to a same UE group. A UE may determine/derive its location or range based on a received carrier wave (signal). More specifically, the UE may determine/derive its location or range from a network/intermediate node based on a received power of a carrier wave (signal) transmitted from the network/intermediate node. The UEs in the same location and/or the same range may mean the UEs with the same received power range of the carrier wave (signal). Preferably and/or alternatively in certain embodiments, the UEs in a same location and/or same position range may be distributed to different UE groups. The UEs among the range which could receive the same power source, carrier wave, and/or NW signal may be (randomly) distributed to different UE groups.

### Proper Configuration

The first condition(s) may include that the proper configuration is received, available, and/or valid. For example, the first condition is fulfilled (at least) if the proper configuration is received, available, and/or valid. The first condition is fulfilled (at least) if a corresponding configuration for a first factor is received, available, and/or valid. The first condition is fulfilled (at least) if the configuration related to the first factor is received, available, and/or valid. The first condition is fulfilled (at least) if the configuration specific to one of the first factors is selected. The configuration may be associated with a first factor. The configuration may be different based on the first factor. The UE may determine whether a configuration is proper based on the first factor.

The configuration may comprise any one or more of the following:
Configuration related to a Bandwidth Part (BWP):
The configuration may be (or include) any of: initialUplinkBWP, initialDownlinkBWP, BWP, subcarrierSpacing, BWP-Downlink, BWP-DownInkCommon, BWP-DownlinkDedicated, BWP-Id, BWP-Uplink, BWP-UplinkCommon, and/or BWP-UplinkDedicated.
The UE may be configured with one or more BWPs of a cell. Alternatively and/or additionally, a cell may include or indicate more than one BWP (for ambient IoT). The UE may be configured with different initial BWPs in different bands and/or frequencies of a cell. The UE may be configured with multiple BWPs with spectrum deployment in-band to a New Radio (N_{R}) cell. There may be different/separate RA configurations and/or RA resources configured on the more than one BWP. The RA configuration and/or RA resources may correspond to, be associated with, and/or be used by (one or more) UEs, UE groups, UE types, power levels, UL data types, and/or UL data sizes. The BWP may be a UL BWP.
Preferably in certain embodiments, the BWP (in above or below) may be changed/represented/replaced by a frequency (sub-) band or frequency resource set.
Preferably in certain embodiments, when the UE receives/detects a carrier wave (signal), the UE may derive/determine a BWP, an (initial) frequency (sub-) band or (initial) frequency resource set based on at least frequency (e.g., DL carrier or DL frequency band), e.g., frequency of a received/detected carrier wave (signal). Preferably in certain embodiments, the UE may derive/determine a BWP, a (initial) frequency (sub-) band, or (initial) frequency resource set based on at least BWP, frequency (sub-) band or frequency resource set information provided from the network.
Configuration related to RA:
The configuration may be (or include) any of: 4-step RA configuration, 2-step RA configuration, contention-based RA configuration, contention-free RA configuration, RA resource configuration, RA preamble configuration, RA preamble group configuration, RACH-ConfigCommon, PRACH configuration, RACH-ConfigCommonTwoStepRA, RACH-ConfigDedicated, RACH-ConfigGeneric, and/or RACH-ConfigGenericTwoStepRA.
The UE may be configured with multiple RA configurations for a cell. Alternatively and/or additionally, a cell may provide or indicate multiple RA configurations (for ambient IoT). The UE may be configured with multiple RA resources groups. Alternatively and/or additionally, the cell may provide or indicate multiple RA resources groups (for ambient IoT). The UE may be configured with multiple RA configuration groups. Alternatively and/or additionally, the cell may provide or indicate multiple RA configuration groups (for ambient IoT). The multiple RA configurations, RA resources group, and/or RA configuration groups may be configured on different BWPs. The multiple RA configurations, RA resources group, and/or RA configuration groups may be configured on a same BWP. The RA configuration, RA resources group, and/or RA configuration group may correspond to, be associated with, and/or be used by (one or more) UEs, UE groups, UE types, power levels, UL data types, and/or UL data size.
Configuration related to data transmission or reception:
The configuration may be (or include) any of: PUSCH-Config, PUSCH-ConfigCommon, PUSCH-ServingCellConfig, PDSCH-Config, PDSCH-ConfigCommon, PDSCH-ServingCellConfig, Semi-Persistent Scheduling (SPS) configuration, configured grant configuration, and/or Hybrid Automatic Repeat Request (HARQ) configuration.
The UE may be configured with at least a configuration related to data transmission or reception. The UE may be pre-configured with at least the configuration. The UE may use (or apply) a pre-configured (or fixed) value for the configuration. The UE may not require the configuration. The UE may not require the network to provide the configuration.
Configuration related to small data transmission:
The configuration may be (or include) any of: SDT-Config, SDT-MAC-PHY-CG-Config, SDT-ConfigCommonSIB, MT-SDT-ConfigCommonSIB, CG-SDT-Configuration, and/or Small Data Transmission (SDT) configuration.
The UE may be configured with at least a configuration related to small data transmission. The UE may be pre-configured with at least the configuration. The UE may use (or apply) a pre-configured (or fixed) value for the configuration. The UE may not require the configuration. The UE may not require the network to provide the configuration.

### Time Offset/Delay

The first condition(s) may include that a first time duration is a passed or current timing (e.g., when the UE receives a NW signal, determines to initiate an RA procedure and/or checks the first condition, when an RA procedure is pending or suspended) is after a first time duration. For example, the first condition is fulfilled (at least) if a first time duration is passed or the current timing is after a first time duration. The first time duration may be a time offset and/or time delay. The first time duration may be represented or counted by a first timer. The first time duration may be a duration when the first timer is running. The first condition is fulfilled (at least) if the first timer expires. The ((maximum) value of) first time duration may be configured, pre-defined, and/or provided by the NW, e.g., via the NW signal (as described above). The (value of) the first time duration may be (randomly) selected, derived, and/or calculated by the UE (e.g., between 0 and the maximum value). The UE may determine the first time duration based on the first factor.

The first time duration may be used to delay (initiating, triggering, continuing, and/or resuming) an RA procedure. Alternatively and/or additionally, the first time duration may be used to delay performing the RA resource selection procedure (or RA preamble transmission procedure or MSGA transmission procedure) of the RA procedure. The first time duration and/or first timer may be started when the NW signal is received, an RA procedure is triggered or pending, (one or more) first condition is fulfilled, the UE determines to initiate an RA procedure, the UE initiates (or triggers or continues or resumes) an RA procedure, (one or more) RA resources selection (step) is performed, and/or a transmission (of MSGA/msg1/msg3) is performed.

### Prohibit Timer

The first condition(s) may include that a second time duration is a passed or current timing (e.g., when the UE receives a (NW) signal, determines to initiate an RA procedure, and/or checks the first condition, when an RA procedure is pending or suspended) is after a second time duration. The second time duration may be counted or represented by a second timer. For example, the first condition is fulfilled (at least) if a second timer is not running. The first condition is fulfilled (at least) if the second timer expires. The second timer may be a time window. The ((maximum) value of) second time duration may be configured, pre-defined, provided and/or enabled by the NW, e.g., via the NW signal (as described above). The (value of) second time duration may be (randomly) selected, derived, and/or calculated by the UE (e.g., between 0 and the maximum value). The UE may determine the second time duration based on the first factor.

The second time duration may be used to prohibit the UE from initiating and/or performing an RA procedure. The second time duration may be used to prohibit the UE from initiating and/or performing an RA procedure in a short time (or promptly) after completing another RA procedure or before the RA procedure. The second time duration may be started when or in response to an RA procedure is triggered, (one or more) first condition(s) is fulfilled, the UE determine to initiate an RA procedure, (one or more) RA resources selection (step) is performed, a data or signal transmission (of MSGA/msg3/msg5) is performed, the RA procedure is (considered as) (successfully) completed. The data or signal transmission may use a Physical Uplink Shared Channel (PUSCH) resource of an MSGA and/or a UL grant provided from the NW. The data or signal transmission may be performed during the RA procedure or after the RA procedure is completed.

Alternatively and/or additionally, the UE may set a time stamp. The first condition(s) may include that the time stamp is a passed or current timing (e.g., when the UE receives a (NW) signal, determines to initiate an RA procedure, and/or checks the first condition, when an RA procedure is pending or suspended) is after the time stamp. Alternatively, the first condition(s) may include that the time stamp plus the second time duration is a passed or current timing (e.g., when the UE receives a NW signal, determines to initiate an RA procedure, and/or checks the first condition, when an RA procedure is pending or suspended) is after the time stamp plus the second time duration. The first condition is fulfilled (at least) after the time stamp. The time stamp may be indicated, configured, pre-defined, provided, and/or enabled by the NW, e.g., via the NW signal (as described above). The time stamp may be (randomly) selected, derived, and/or calculated by the UE. The time stamp may be set by the value of the second timer. The time stamp may be set by the remaining time of the second timer. The time stamp may be set by the time or date (e.g., epoch time) that an RA procedure is triggered, (one or more) first condition(s) is fulfilled, the UE determines to initiate an RA procedure, (one or more) RA resources selection (step) is performed, a data or signal transmission (of MSGA/msg3/msg5) is performed, the RA procedure is (considered as) (successfully) completed.

Alternatively and/or additionally, the UE may store the value (or remaining time) of the second time duration or the time stamp, e.g., based on the power level. The UE may not clear the value (or remaining time) of the second time duration or the time stamp when, if or in response to power turning off, going to idle state, and/or resetting MAC. The UE may retrieve and/or restore the value (or remaining time) of the second time duration or the time stamp, e.g., based on the power level.

In response to receiving a first signaling of triggering the random access procedure, the UE may determine whether to trigger a second random access procedure based on the first condition. The first signaling may be a paging for ambient IoT. The first signaling may indicate an ID or group ID of the UE. The first condition may include that a time duration is passed (e.g., a timer is not running, a first time duration has elapsed). The time duration may be started when the UE triggers another random access procedure before receiving the first signaling. The time duration may be started when the first random access procedure is completed. The UE may be prohibited to trigger the second random access procedure in response to receiving the first signaling during the time duration.

In one example, the UE may receive a first signaling of triggering a random access procedure. In response to receiving the first signaling, the UE may determine whether to trigger the random access procedure or not based on a first condition. The first condition includes at least one of: a timer is running or not; and a first time duration has elapsed or not. The first signaling may be a paging for ambient IoT. The first signaling may indicate an ID or a group ID of the UE. The first signaling may indicate a value of the timer or the first time duration. The value may be a default value. The first signaling may indicate an index of the value. The value may be a fixed value. The value may be a dynamic/configurable value. The timer and/or the first time duration may be started when the UE triggers a second random access procedure before receiving the first signaling. The timer and/or the first time duration may be started when a transmission is performed in the second random access procedure. The timer and/or the first time duration may be started when the second random access procedure is completed. The timer and/or the first time duration may be started when receiving the first signaling. The second random access procedure may be triggered in response to receiving a second signaling. The UE may not trigger the random access procedure if (at least) the timer is running and/or the determining is performed during the first time duration. The UE may trigger the random access procedure if (at least) the timer is not running and/or the determining is performed after the first time duration. The timer may be a prohibit timer. The first condition may include that the UE receives a configuration related to data transmission or reception, e.g., in the first signaling. The timer and/or the first time duration is associated with the configuration.

In one example, the UE (e.g., the UE1 in FIG. 9) may receive a first signaling of triggering a random access (procedure) (e.g., the first Paging for a group of UE1 in FIG. 9). The UE may determine to trigger/initiate/perform a first random access procedure, e.g., based on at least a first timer is not running, the first timer has expired and/or there is not an (ongoing) first time duration. The UE may perform a first transmission (e.g., a response to the first signaling) in the first random access procedure (e.g., the first Response in FIG. 9). The UE may receive a second transmission in response to the first transmission. The UE may be indicated and/or be acknowledged that the first random access procedure, the first transmission, the response, and/or a procedure/request indicated by the first signaling is successful and/or is (successfully) completed. The UE may consider the first random access procedure, the first transmission, the response, and/or a procedure/request indicated by the first signaling is successful and/or is (successfully) completed. The UE may start the first timer or the first time duration in response to, when, upon, and/or after receiving the first signaling, triggering/initiating/performing the first random access procedure, performing the first transmission, receiving the second transmission, and/or considering the first random access procedure, the first transmission, the response is successful or (successfully) completed. The UE may receive a second signaling of triggering random access (procedure) (e.g., the Repeated Paging for a group of UE1 in FIG. 9). The UE may determine not to trigger/initiate/perform a second random access procedure, e.g., based on at least the first timer is running, the first timer has expired, and/or there is an (ongoing) first time duration. As shown in FIG. 9, the UE may not respond to a paging when the first timer is running or during the first time duration. The UE may receive a third signaling of triggering random access (procedure) (e.g., the second Paging for a group of UE1 in FIG. 9). The UE may determine to trigger/initiate/perform a third random access procedure, e.g., based on at least the first timer is not running, the first timer has expired and/or there is not an (ongoing) first time duration. The UE may perform a third transmission (e.g., a response to the third signaling) in the third random access procedure (e.g., the second Response in FIG. 9).

In the above example, the first/second/third signaling may be a paging (message) for ambient IoT. The first/second/third signaling may indicate a target ID indicating the UE (e.g., a UE ID, a group ID). The first/second/third signaling may provide/indicate resources for the UE to perform the first random access procedure. The first/second/third signaling may indicate a request or service (e.g., command, inventory). The first/second/third signaling may indicate (the value/length of) the first timer and/or the first time duration. The first time duration may be an offset. The first signaling and the second signaling may be different signalings. The second signaling may be a replica of the first signaling. The first signaling and the second signaling may indicate the same request or service. The first signaling and the second signaling may indicate the same target ID. The third signaling may be a signaling different the first signaling and the second signaling.

In one example, the UE receives a first signaling of/for triggering a first random access procedure. In response to receiving the first signaling, the UE determines whether to trigger the first random access procedure or not based on a first condition. The first condition includes (at least) a timer is running or not and/or a first time duration has elapsed or not. The first signaling is a paging for ambient IoT. The first signaling is a paging message. The first random access procedure is an ambient IoT random access procedure. The first signaling indicates an ID or a group ID of the UE. The first signaling indicates a set of UEs. The UE belongs to the set of UEs. The set of the UEs includes the UE. The first signaling indicates a value of the timer or a time length of the first time duration. The timer is a prohibit timer. The timer is a random access prohibit timer. The first signaling is transmitted from a reader. The reader is a network node, an intermediate node, or another UE.

In one example, the UE receives a second signaling of/for triggering a second random access procedure before receiving the first signaling or the first random access procedure. The UE triggers or performs the second random access procedure in response to receiving the second signaling. The second random access procedure is triggered, performed, and/or started before the first random access procedure. The second signaling indicates a value of the timer or a time length of the first time duration.

In one example, the timer and/or the first time duration is started when the UE triggers the second random access procedure. The timer and/or the first time duration is started when the UE performs a transmission in the second random access procedure. The timer and/or the first time duration is started when the second random access procedure is completed. The timer and/or the first time duration is started when receiving the second signaling.

In one example, the first signaling and the second signaling indicate a same target ID. The UE corresponds or belongs to the target ID. The target ID corresponds to and/or includes the UE. The first signaling and the second signaling indicate a same request or same service. The request and/or service (type) may be or comprise a (type of) command (e.g., read, write) and/or an inventory (request).

In one example, the UE does not trigger the first random access procedure if (at least) the timer is running and/or if (at least) the determining is performed during the first time duration. The UE triggers the first random access procedure if (at least) the timer is not running or if (at least) the determining is performed after the first time duration and/or the first time duration has elapsed.

In one example, the first condition includes that the UE receives a configuration related to data transmission or reception.

In one example, the UE receives a second signaling of/for triggering a second random access procedure. In response to receiving the second signaling, the UE triggers the second random access procedure. The UE performs a transmission during the second random access procedure. The UE starts a timer and/or (counting) a first time duration when one of the following timing: the UE triggers the second random access procedure, the UE performs the transmission during the second random access procedure, the second random access procedure is completed, or the UE receiving the second signaling. The UE receives a first signaling of/for triggering a first random access procedure. In response to receiving the first signaling, the UE determines whether to trigger the first random access procedure or not based on a first condition. The first condition includes at least one of the timers is running or not and the first time duration has elapsed or not. The first signaling and the second signaling are paging for ambient IoT and/or paging messages. The first random access procedure and the second random access procedure are ambient IoT random access procedures. The first signaling and the second signaling indicate a same ID or a same group ID of the UE. The first signaling and the second signaling indicate a same set of UEs. The UE belongs to the set of UEs. The first signaling and the second signaling indicate a same target ID. The UE corresponds or belongs to the target ID. The first signaling and the second signaling indicate a same request or same service (e.g., command, inventory). The first signaling and/or the second signaling indicate a value of the timer or a time length of the first time duration. The UE receives the second signaling before receiving the first signaling or the first random access procedure. The second random access procedure is triggered, performed, started before the first random access procedure. The UE does not trigger the first random access procedure if (at least) the timer is running and/or if (at least) the determining is performed during the first time duration. The UE triggers the first random access procedure if (at least) the timer is not running, if (at least) the determining is performed after the first time duration and/or the first time duration has elapsed. The timer is a prohibit timer and/or a random access prohibit timer. The first signaling and the second signaling are transmitted from a reader. The reader is a network node, an intermediate node, or another UE.

The first factor may be one or more of the following:

### Power Level (as Described in the First Condition)

### UE Type

There may be two or more types of UEs. The UE types may be differentiated by at least energy storage, method to perform UL transmission, power level, and/or device size. Preferably in certain embodiments, the method to perform UL transmission may be generated internally by the device/UE or be backscattered on the carrier wave (signal) provided externally.

For example, a first type UE may be a device A or device B, e.g., as considered in [2] 3GPP TR 38.848 V18.0.0. The first type UE may have (or be equipped with) battery or energy storage. The first type UE may not have (or be equipped with) battery or energy storage. The first type UE may not have (or be equipped with) DL/UL amplification. The first type UE may be a passive or semi-passive device. The first type UE may generate UL transmission by backscattering. The first type UE may perform backscattering transmissions. The first type UE may not be able to generate a UL transmission (internally) by itself. The first type UE may not have capability to generate a signal without backscattering.

For example, a second type UE may be a device C, e.g., as considered in [2] 3GPP TR 38.848 V18.0.0. The second type UE may have (or be equipped with) battery or energy storage. The second type UE may have (or be equipped with) DL/UL amplification. The second type UE may be an active device. The second type UE may generate a UL transmission by backscattering. The second type UE may perform a backscattering transmission. The second type UE may be able to generate UL transmission (internally) by itself. The second type UE may have capability to generate a signal without backscattering.

### (UL) Data Type

The (UL) data types may be differentiated by at least use case, traffic scenario, service type, Quality of Service (QOS), logical channel (group), and/or topology. The (UL) data type may be indicated by the network or indicated by the higher layer of the UE. The UE may initiate or trigger the RA procedure for transmitting the (UL) data.

### (UL) Data Size

The (UL) data size may be calculated/derived/determined by the UE. The (UL) data size may be corresponding to the (UL) data type. The (UL) data size may be (potential) Transport Block Size (TBS) of an MSGA payload and/or an Msg3. The (UL) data size may be (potential) TBS of the first transmission in the RA procedure. The (UL) data size may be TBS of ambient IoT information (or data). The UE may initiate or trigger the RA procedure for transmitting the (UL) data.

### Ue Id

A UE may be assigned a UE ID. The UE may be predefined or (pre-)configured (e.g., by the UE) the UE ID. The UE may be configured or indicated (e.g., by the NW) the UE ID. The UE may calculate, select, derive, or determine the UE ID by itself.

### UE Group (as Described in the First Condition)

The UE may receive configurations related to ambient IoT. The UE may receive RA configurations and/or RA resources. The RA resources may comprise BWP, RA resources/configuration group, RA preamble (group), Random Access Channel (RACH) occasion(s), and/or PUSCH occasion(s). Throughout the present disclosure, the following may be interchangeable: RACH occasion(s), Physical Random Access Channel (PRACH) occasion(s).

The power level may be (represented) a power status of the UE.

Throughout the present disclosure, the “RA procedure” may be replaced by “(initial) access procedure”.

Throughout the present disclosure, the “RA procedure” may be changed/represented/replaced as a UE (or ambient IoT) data transmitting procedure, UE (or ambient IoT) response procedure, or UE (or ambient IoT) reporting procedure.

Throughout the present disclosure, the “RA” may be replaced by “access”.

Throughout the present disclosure, the “MSGA” or “MSGA payload” may be replaced by “(uplink) data and/or signaling”.

Throughout the present disclosure, the “PRACH” may be replaced by “channel for random access” or “PRACH for ambient IoT”.

Throughout the present disclosure, the “PUSCH” may be replaced by “uplink shared channel” or “PUSCH for ambient IoT”.

Throughout the present disclosure, the “PDCCH” may be replaced by “downlink control channel”, “downlink control information”, or “PDCCH for ambient IoT”.

Throughout the present disclosure, the “Physical Downlink Shared Channel (PDSCH)” may be replaced by “downlink shared channel” or “PDSCH for ambient IoT”.

Throughout the present disclosure, the “BWP” may be replaced by “sub-band of/in a cell” or “subset of the total cell bandwidth of a cell”.

Throughout the present disclosure, the “RACH” may be replaced by “access channel” or “RACH for ambient IoT”.

Throughout the present disclosure, the “cell” may be replaced by “intermediate node”.

Throughout the present disclosure, the network (node) may be changed/represented/replaced as intermediate node.

The UE may be referred to the UE, an RRC layer of the UE, a MAC entity of the UE, or physical layer of the UE.

Throughout the present disclosure, the UE may be an ambient IoT device/UE. The UE may be a device used for ambient IoT. The UE may be a device capable of ambient IoT. The UE may be an NR device. The UE may be a Long Term Evolution (LTE) device. The UE may be a IoT device. The UE may be a wearable device. The UE may be a sensor. The UE may be a stationary device. The UE may be a tag. Throughout the present disclosure, the following may be interchangeable: (ambient IoT) UE, (ambient IoT) device.

The UE may not be a legacy UE. The legacy UE may be a non-ambient IoT device. The legacy UE may perform different procedures from the ambient IoT UE. The UE may be a legacy UE with capability to perform an ambient IoT procedure. Throughout the present disclosure, the following may be interchangeable: normal UE, legacy UE. The ambient IoT UE may have capability of an ambient IoT. The legacy UE may or may not have capability of an ambient IoT procedure.

The network may be a network node. The network (node) may be a base station. The network (node) may be an access point. The network (node) may be an Evolved Node B (eNB). The network (node) may be a Next Generation Node B (gNB). The network (node) may be a gateway.

Various examples and embodiments of the present invention are described below. For the methods, alternatives, concepts, examples, and embodiments detailed above and herein, the following aspects and embodiments are possible.

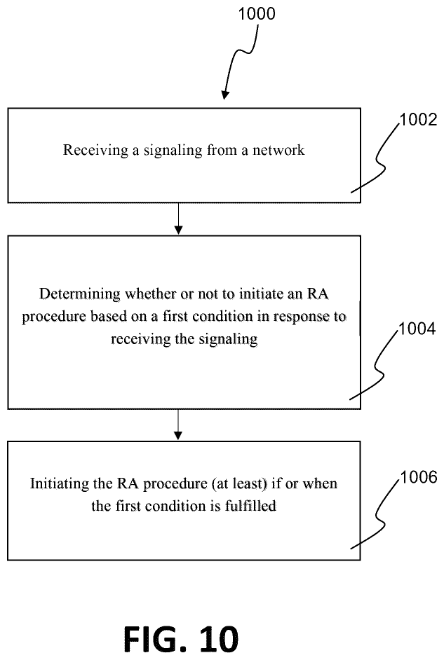

Referring to FIG. 10, with this and other concepts, systems, and methods of the present invention, a method 1000 for a UE in a wireless communication system comprises receiving a signaling from a network (step 1002), determining whether or not to initiate an RA procedure based on a first condition in response to receiving the signaling (step 1004), and initiating the RA procedure (at least) if or when the first condition is fulfilled (step 1006).

In various embodiments, the signaling indicates the UE to trigger the RA procedure and/or perform a UL transmission.

In various embodiments, the first condition is that a power level of the UE is fulfilled.

In various embodiments, the first condition is that a UE group of the UE is indicated in the signaling.

In various embodiments, the first condition is that a corresponding RA configuration is available for the UE based on UE type.

In various embodiments, the first condition is that a time duration is passed or a timer is not running.

In various embodiments, the initiating the RA procedure comprises performing an RA resource selection procedure and/or performing the UL transmission.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a signaling from a network; (ii) determine whether or not to initiate an RA procedure based on a first condition in response to receiving the signaling; and (iii) initiate the RA procedure if or when the first condition is fulfilled. Moreover, the CPU 308 can execute the program code 312 to perform all of the described actions, steps, and methods described above, below, or otherwise herein.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) receive a signaling from a network; (ii) determine whether or not to initiate an RA procedure based on a first condition in response to receiving the signaling; and (iii) initiate the RA procedure (at least) if or when the first condition is fulfilled. Moreover, the CPU 308 can execute the program code 312 to perform all of the described actions, steps, and methods described above, below, or otherwise herein.

Throughout the present disclosure, the “DL” may be replaced by “Reader to Device (R2D).” A DL transmission may be, be referred to, and/or be supplemented by a transmission from a reader to a device and/or an R2D transmission. A DL data may be, be referred to, and/or be supplemented by a data available on a reader side, a data to be transmitted from a reader to a device, and/or an R2D data. A DL transmission and/or DL data may comprise an indication, configuration, signal/signaling/signalling, and/or message from a reader.

Throughout the present disclosure, the “UL” may be replaced by “Device to Reader (D2R).” A UL transmission may be, be referred to, and/or be supplemented by a transmission from a device to a reader and/or a D2R transmission. An UL data may be, be referred to, and/or be supplemented by a data available on a device side, a data to be transmitted from a device to a reader, and/or a D2R data. An UL transmission and/or UL data may comprise an indication, signal/signaling, and/or message from a device. An UL grant may be one or more resources provided from the reader/NW/intermediate node, used by the device/UE, and/or used to transmit/perform D2R transmission.

Throughout the present disclosure, the reader may be and/or be replaced by NW/intermediate node, UE, and/or intermediate node. Throughout the present disclosure, the device may be and/or be replaced by UE and/or intermediate node. The device may be referred to as an ambient IoT device. The “UE” may comprise a reader and/or device. The “NW/intermediate node” may comprise a reader.

The UE/device may receive carrier wave(s) from a reader. The UE/device may receive carrier wave(s) from a node other than the reader.

Throughout the present disclosure, the “RA (random access)” may be, be replaced by, and/or be referred to an access procedure performed by the (ambient IoT) UE/device. The resource(s) and/or configuration(s) for the access procedure may comprise PDRCH resource(s), occasion(s), frequency, and/or band, e.g., for D2R transmission. The resource(s) and/or configuration(s) for the access procedure may comprise a parameter, random number, group number, and/or assistance information, e.g., for D2R transmission.

Throughout the present disclosure, the “2-step RA” may be, be replaced by, and/or be referred to a 2-step access procedure performed by the (ambient IoT) UE/device.

Throughout the present disclosure, the “4-step RA” may be, be replaced by, and/or be referred to a 4-step access procedure performed by the (ambient IoT) UE/device.

The UE may perform a procedure of an RA, (initial) access, (ambient IoT) response/report, and/or (R2D/D2R) transmission. The procedure may be a procedure described above. The UE may access the NW/intermediate node, receive signaling/message/configuration, and/or transmit (D2R) data via the procedure. The UE may receive a signaling from the NW/intermediate node (e.g., from a reader). The signaling may be a signaling described above. The signaling may be a query, paging, indication, and/or a R2D message.

In response to receiving the signaling, the UE (e.g., ambient IoT UE/device) may trigger/perform the procedure (e.g., RA procedure) and/or the following transmission. In the procedure, the UE may transmit a first transmission to the NW/intermediate node. The NW/intermediate node may transmit a second transmission to the UE in response to reception/detection of the first transmission. In response to or after transmitting the first transmission, the UE may receive a second transmission from the NW/intermediate node. Alternatively, there may be no response in response to the first transmission. For this case, the RA procedure may be completed in response to transmitting the first transmission. In response to receiving the second transmission, the UE may transmit a third transmission to the NW/intermediate node. The NW/intermediate node may transmit a fourth transmission to the UE in response to reception of the third transmission. The NW/intermediate node may not transmit the fourth transmission to the UE in response to reception of the third transmission. In response to or after transmitting the third transmission, the UE may or may not receive a fourth transmission from the NW/intermediate node. In response to receiving the fourth transmission, the UE may transmit a fifth transmission to the NW/intermediate node.

The first transmission in the procedure may be/comprise information of a random number, information of a preamble number, and/or information of an (access) ID selected/generated/determined by the UE.

The second transmission in the procedure may be a response to the first transmission and/or an acknowledge. The second transmission may indicate, identify, and/or correspond to the first transmission. The second transmission may provide resource(s) for the following D2R transmissions, e.g., the third transmission.

The third transmission in the procedure may be/comprise information of a device/UE ID, report, assistance information, D2R data, and/or information from the UE.

The fourth transmission in the procedure may be a response to the third transmission, an acknowledge, DL/R2D command, R2D data, and/or a scheduling. The fourth transmission may indicate, identify, and/or correspond to the third transmission. The fourth transmission may provide resource(s) for the following D2R transmissions. The fourth transmission may indicate, notify, and/or allow the fifth transmission.

The fifth transmission in the procedure may be/comprise a feedback (of the fourth transmission), report, assistance information, D2R data, and/or information from the UE.

The first transmission, third transmission, and fifth transmission may be D2R transmissions and/or PDRCH transmissions. The signaling, second transmission, and fourth transmission may be R2D transmissions and/or PRDCH transmissions. The signaling and second transmission may be broadcast, provided, and/or transmitted to one or multiple UEs. The second transmission and fourth transmission may be provided and/or transmitted to a dedicated UE. The fourth transmission and/or the fifth transmission may be a subsequent transmission during or after the procedure.

Throughout the present disclosure, a Msg1 and/or MSGA may be replaced by a first transmission. Throughout the present disclosure, a Msg2, Random Access Response (RAR) and/or MSGB may be replaced by a second transmission. Throughout the present disclosure, an MSGA and/or Msg3 may be replaced by a third transmission. Throughout the present disclosure, an MSGB and/or Msg4 may be replaced by a fourth transmission. Throughout the present disclosure, an Msg5 may be replaced by a fifth transmission.

An identity of the UE and/or a UE ID may be or comprise a random number, temporary number, preamble number (e.g., Random Access Preamble ID (RAPID)), and/or ID selected/generated/determined by the UE. An identity of the UE and/or a UE ID may be or comprise a device ID, UE ID, group ID, Contention Resolution Identity and/or Radio Network Temporary Identifier (RNTI) of the UE. The (access) ID comprised in the first transmission may be different from the device/UE ID comprised in the third transmission.

Throughout the present disclosure, the following may be interchangeable: “initiate a procedure”, “perform a procedure”, “trigger a procedure”, and/or “execute a procedure.”

Throughout the present disclosure, the Common Control Channel (“CCCH”), “PRACH”, “RACH”, “PUSCH” and/or Physical Uplink Control Channel (“PUCCH”) may be, be comprised by, be replaced by, and/or be referred to “physical device to reader channel”, a channel for transmission from device to reader, and/or PDRCH. Throughout the present disclosure, the “PDSCH” and/or “PDCCH” may be, be comprised by, be replaced by, and/or be referred to “physical reader to device channel”, a channel for transmission from reader to device, and/or PRDCH. A D2R transmission may be transmit via a PDRCH. A R2D transmission may be transmit via a PRDCH.

Throughout the present disclosure, the “RA resource(s)/configuration(s)”, “UL resource(s)/configuration(s)”, and/or “resource(s)/configuration(s)” may be, be replaced by, and/or be referred to resource(s)/configuration(s) for D2R transmission (e.g., as described above). The resource(s) and/or configuration(s) may comprise PDRCH (transmission) resource(s), occasion(s), channel resource(s), frequency resources, and/or (sub-) band(s), e.g., for D2R transmission. The resource(s) and/or configuration(s) may comprise parameter, random number, group number, and/or assistance information, e.g., for D2R transmission.

The UE may monitor/receive the PRDCH in the procedure of RA, (initial) access and/or (R2D/D2R) transmission.

A UE may determine/derive its location or range based on a received R2D signal/channel, and/or PRDCH. More specifically, the UE may determine/derive its location or range from a network/intermediate node based on an R2D signal/channel, and/or PRDCH transmitted from the network/intermediate node. The UEs in the same location and/or the same range may mean the UEs with the same received power range of the R2D signal/channel, and/or PRDCH. The UEs among the range in which could receive the same R2D signal/channel and/or PRDCH may be (randomly) distributed to different UE groups.

The configuration may be (or include) any of transmission bandwidth configuration, occupation bandwidth configuration, channel bandwidth configuration, and/or system bandwidth configuration.

Preferably in certain embodiments, the BWP (in above or below) may be changed/represented/replaced by system bandwidth/band and/or transmission bandwidth/band. The BWP, bandwidth, and/or band may be for R2D and/or D2R.

Preferably in certain embodiments, when the UE receives/detects PRDCH, R2D signal/channel, and/or carrier wave (signal), the UE may derive/determine a BWP, a (initial) frequency (sub-) band or (initial) frequency resource set based on at least frequency of a received/detected PRDCH, R2D signal/channel, and/or carrier wave (signal).

The configuration may be (or include) any of: PRDCH configuration, PDRCH configuration, transmission bandwidth configuration, occupation bandwidth configuration, channel bandwidth configuration, and/or system bandwidth configuration.

The data or signal transmission may use PDRCH resources provided from the NW.

The RA resources selection (step) may be one or more of the following:
(initial) (UL) BWP (for ambient IoT);
RA resources/configuration (group) (for ambient IoT);
RA/transmission type (for ambient IoT), e.g., based on the first factor and/or the first condition;
RA preamble (group and/or index) (for ambient IoT);
RACH occasion (for ambient IoT);
PUSCH occasion (for ambient IoT); and/or
PDRCH occasion (for ambient IoT).

The UE may receive PDRCH occasion(s). The PDRCH occasion(s) may be a time and/or frequency resource for a PDRCH transmission or a D2R transmission.

The “(initial) access procedure” may be contention-based or contention-free.

Throughout the present disclosure, the “MSGA” or “MSGA payload” may be replaced by “PDRCH data/transmission/signaling”, “(uplink/D2R) data” and/or “(uplink/D2R) signaling”.

Throughout the present disclosure, the “PRACH” may be replaced by “PDRCH”.

Throughout the present disclosure, the “PUSCH” may be replaced by “PDRCH” or “physical channel for D2R (data/control) transmission”.

Throughout the present disclosure, the “PDCCH” may be replaced by “PRDCH”, or “physical channel for R2D (data/control) transmission”.

Throughout the present disclosure, the “PDSCH” may be replaced by “PRDCH”, or “physical channel for R2D (data) transmission”.

Throughout the present disclosure, the “BWP” may be replaced by “system bandwidth”, “channel bandwidth”, “transmission bandwidth” or “occupation bandwidth”.

Throughout the present disclosure, the “RACH” may be replaced by “PDRCH”.

Throughout the present disclosure, the “PDRCH” may be replaced by “physical channel for D2R (data) transmission”.

Throughout the present disclosure, the “PRDCH” may be replaced by “physical channel for R2D (data) transmission”.

Throughout the present disclosure, the (data and/or signaling) transmission from reader to device/UE may be via PRDCH. Throughout the present disclosure, the (data and/or signaling) transmission from device/UE to reader may be via PDRCH.

Throughout the present disclosure, the “downlink control information” may be replaced by R2D control information.

Throughout the present disclosure, the “uplink control information” may be replaced by D2R control information.

Throughout the present disclosure, the downlink control information may be transmitted via PRDCH or R2D command.

As specified in TS38.213 ([7] 3GPP TS 38.213 V17.7.0), for uplink transmissions, the UE performs uplink power control to determine UE transmit power for PUSCH, PUCCH, Sounding Reference Signal (SRS), and PRACH transmission. For sidelink transmissions, the UE performs sidelink power control to determine UE transmit power for Secondary Synchronization Signaling (S-SS)/Physical Sidelink Broadcast Channel (PSBCH) block (S-SSB), Physical Sidelink Shared Channel (PSSCH), Physical Sidelink Control Channel (PSCCH), Physical Sidelink Feedback Channel (PSFCH) transmission.

Generally, power control for determining UE transmit power is utilized for guaranteeing receiving performance, and also for avoiding power waste and mitigating interference. If UE transmit power is not enough, it may induce receiver (e.g., network node in uplink, or UE in sidelink) has lower Reference Signal Received Power (RSRP)/Signal to Interference Plus Noise Ratio (SINR) in reception and decoding. It is possible that the UE may need to perform retransmissions or repeated transmissions for receiver to decode it successfully. Such retransmissions or repeated transmissions will also require more resource(s) for the UE. If the UE transmit power is too much, it may induce interference in neighboring resources, which may be utilized by other UE's transmission(s), with impact on system performance.

In the current N_{R} design, UE power control includes some parameters, such as:
restriction of maximum UE transmit power (e.g., UE configured maximum output power P_{CMAX}, maximum power restriction due to Channel Busy Ratio (CBR) P_{MAX,CBR});
expected/targeted received power P_{O} (P_{O} may be provided by configuration);
pathloss PL (e.g., utilize DL pathloss in uplink power control, utilize DL and/or sidelink (SL) pathloss in sidelink power control);
pathloss compensation factor α_{PL} (α_{PL} may be provided by configuration or specified as 1);
frequency resource of transmission M_{RB};
power control adjustment state (e.g., utilized in closed-loop power control based on TPC command); and/or
some other parameter(s), if any.

According to the study item of ambient IoT ([1] RP-234058), an ambient IoT UE has limited energy storage (may possibly even with no energy storage). Comparing N_{R} UE with power consumption of mW (e.g., maximum UE transmit power 23 dBm corresponds to 199.5 mW), output power of the ambient IoT UE may be typically from 1 μW to a few hundreds of μW. Currently, the general scope is to address the following types of ambient IoT UEs:

A first type of ambient IoT UE may have 1 μW peak power consumption, with energy storage, with neither DL nor UL amplification. Transmission from the first type of ambient IoT UE may be backscattered on a carrier wave provided externally.

A second type of ambient IoT UE may have ≤a few hundred μW peak power consumption, with energy storage, with DL, and/or UL amplification. Transmission from the second type of ambient IoT UE may be backscattered on a carrier wave provided externally or generated internally by the UE.

There will be issues given such limited power consumption, how to achieve some ambient IoT targets, such as data transport (e.g., Device-Originated-Device-Terminated Triggered (DO-DTT) and Device-Terminated (DT) data transmission), reception performance, coverage (e.g., distance of 10-50 m or more).

To deal with the above and herein issues, various concepts, examples, mechanisms, methods, and embodiments are provided below.

A UE may perform a first transmission with a first transmit power. Preferably in certain embodiments, the first transmission may be a backscattering transmission. Preferably and/or alternatively in certain embodiments, the first transmission may be generated internally by the UE. Preferably in certain embodiments, the first transmission may be an uplink transmission from the UE to a network node or an intermediate node (e.g., a UE). Preferably in certain embodiments, the first transmission may be a sidelink transmission from the UE to another UE/device (e.g., an intermediate node). Preferably in certain embodiments, the first transmission may be any of preamble transmission (e.g., PRACH), uplink data transmission (e.g., PUSCH), uplink control transmission (e.g., PUCCH), sidelink data transmission (e.g., PSSCH), access transmission (e.g., MSGA), or reference signal transmission (e.g., Demodulation Reference Signal (DMRS) or SRS).

Preferably in certain embodiments, the UE may receive/detect a carrier wave (signal) in a carrier wave time duration. Preferably in certain embodiments, the UE may perform the first transmission in a first timing within the carrier wave time duration and/or associated with the carrier wave time duration.

Preferably in certain embodiments, the UE may perform the first transmission one-shot. Preferably in certain embodiments, the first transmission may be a new/initial transmission or a retransmission.

Preferably and/or alternatively in certain embodiments, the UE may perform a number of repeated transmissions (e.g., transmission repetition or bundled transmission). Preferably in certain embodiments, the first transmission may be the first one transmission or initial one transmission among the number of repeated transmissions. Preferably in certain embodiments, the number of the repeated transmissions may be determined/derived based on a repetition factor. Preferably in certain embodiments, the number of the repeated transmissions may be equal or set to the value of the repetition factor. Preferably in certain embodiments, if/when the repetition factor is 1, the UE may (fallback to) perform the first transmission one-shot. Preferably in certain embodiments, the number of the repeated transmissions and/or repetition factor may be configured or indicated by the network (e.g., via paging, SIB, MAC CE, PDCCH order). The number of the repeated transmissions and/or repetition factor may be associated with a (selected) RA configuration or RA resource(s).

### Concept A

The concept A is that the UE (e.g., ambient IoT UE) does not consider DL/SL pathloss for deriving/determining the first transmit power (e.g., for PRACH and/or PUSCH). The UE (e.g., ambient IoT UE) does not perform pathloss-based power control for deriving/determining the first transmit power. The UE (e.g., ambient IoT UE) may determine or derive the first transmit power regardless of the DL/SL pathloss.

The UE may not need (or not be allowed or not support) to be configured with a pathloss reference (for a cell or Primary Cell (PCell)).

Preferably in certain embodiments, a non-ambient IoT UE may perform DL/SL pathloss for deriving/determining its transmit power (e.g., for PRACH and/or PUSCH). The non-ambient IoT UE may perform pathloss-based power control for deriving/determining its transmit power.

In one embodiment A1, the UE may determine/derive the first transmit power with a first predefined/specified/(pre-)configured power value. For instance, the UE may perform the first transmission with the first predefined/specified/(pre-)configured power value at the first timing, e.g., if/when the UE is capable to perform the first transmission with the first predefined/specified/(pre-)configured power value at the first timing. The UE may perform the first transmission with a power up to the first predefined/specified/(pre-)configured power value. The UE may perform the first transmission with a power at least the first predefined/specified/(pre-)configured power value. Preferably in certain embodiments, if/when the UE is not capable to perform the first transmission with the first predefined/specified/(pre-)configured power value at the first timing, the UE may skip or delay/suspend the first transmission at the first timing until the UE is capable to perform the first transmission with the first predefined/specified/(pre-)configured power value at a second timing. The second timing is later than the first timing. Preferably in certain embodiments, the second timing may be with the carrier wave time duration or associated with the carrier wave time duration. The first transmission may be any of preamble transmission (e.g., PRACH), uplink data transmission (e.g., PUSCH), uplink control transmission (e.g., PUCCH), sidelink data transmission (e.g., PSSCH), access transmission (e.g., MSGA), or reference signal transmission (e.g., DMRS or SRS).

Preferable or alternatively, if/when the UE is not capable to perform the first transmission with the first predefined/specified/(pre-)configured power value at the first timing, the UE may perform a second transmission with a second predefined/specified/(pre-)configured power value at the first timing, wherein the second predefined/specified/(pre-)configured power value is smaller than the first predefined/specified/(pre-)configured power value. Preferably in certain embodiments, the second transmission may be to notify/inform/report the power insufficient status of the UE or reporting/accessing delay/suspend of the UE. The first transmission may be any of preamble transmission (preferably PRACH of a first RA type or a first preamble group), uplink data transmission (e.g., PUSCH), uplink control transmission (e.g., PUCCH), sidelink data transmission (e.g., PSSCH), or access transmission (e.g., MSGA). The second transmission may be any of preamble transmission (e.g., PRACH of a second RA type or a second preamble group), uplink control transmission (e.g., PUCCH), or reference signal transmission (e.g., DMRS or SRS). The UE may perform the first transmission with the first predefined/specified/(pre-)configured power value at the second timing, if/when the UE is capable to perform the first transmission with the first predefined/specified/(pre-)configured power value at the second timing.

Preferably in certain embodiments, the first predefined/specified/(pre-)configured power value may be the same or different for different types/kinds of the first transmission. The UE may determine/derive the first transmit power with corresponding first predefined/specified/(pre-)configured power value based on the type/kind of the first transmission. The types/kinds of the first transmission may comprise any of preamble transmission (e.g., PRACH, preferably type/kind of PRACH may comprise RA type and/or preamble group), uplink data transmission (e.g., PUSCH), uplink control transmission (e.g., PUCCH), sidelink data transmission (e.g., PSSCH), access transmission (e.g., MSGA), or reference signal transmission (e.g., DMRS or SRS). The types/kinds of the first transmission may comprise data type if the first transmission comprises data. The types/kinds of the first transmission may comprise data size (e.g., larger or smaller than a data size threshold) if the first transmission comprises data. Preferably in certain embodiments, the first predefined/specified/(pre-)configured power value may be the same or different for different UE types of the UE. The UE may determine/derive the first transmit power with corresponding first predefined/specified/(pre-)configured power value based on the UE type of the UE.

Preferably in certain embodiments, the UE may determine/check its power capability based on its battery or its power status or received carrier wave (signal) (e.g., RSRP of the received carrier wave (signal)).

In one embodiment A2, the UE may determine/derive the first transmit power with a first power value of a set of predefined/specified/(pre-)configured power values. The set of predefined/specified/(pre-)configured power values comprise the first power value. Preferably in certain embodiments, the set of predefined/specified/(pre-)configured power values are quantified power value for the UE to perform the first transmission. The UE may determine/derive the first power value based on its battery or its power status or received carrier wave (signal) (e.g., RSRP of the received carrier wave (signal)). The UE may determine/check its power capability based on its battery or its power status or received carrier wave (signal) (e.g., RSRP of the received carrier wave (signal)).

Preferably in certain embodiments, if/when the UE is capable to perform the first transmission with the first power value of the set and if/when the UE is not capable to perform the first transmission with a next larger power value in the set (i.e., next power value larger than the first power value) in the set, the UE may perform the first transmission with the first power value at the first timing.

Preferably in certain embodiments, if/when the UE is not capable to perform the first transmission with a smallest power value of the set, the UE may skip or delay/suspend the first transmission at the first timing until the UE is capable to perform the first transmission with the smallest power value of the set at a second timing. The first transmission may be any of preamble transmission (e.g., PRACH), uplink data transmission (e.g., PUSCH), uplink control transmission (e.g., PUCCH), sidelink data transmission (e.g., PSSCH), access transmission (e.g., MSGA), or reference signal transmission (e.g., DMRS or SRS). Preferably and/or alternatively in certain embodiments, if/when the UE is not capable to perform the first transmission with the smallest power value of the set, the UE may perform a second transmission with a second power value at the first timing, wherein the second power value is smaller than the smallest power value of the set. Preferably in certain embodiments, the second transmission may be to notify/inform/report the power insufficient status of the UE or reporting/accessing delay/suspend of the UE. The first transmission may be any of preamble transmission (e.g., PRACH of a first RA type or a first preamble group), uplink data transmission (e.g., PUSCH), uplink control transmission (e.g., PUCCH), sidelink data transmission (e.g., PSSCH), or access transmission (e.g., MSGA). The second transmission may be any of preamble transmission (e.g., PRACH of a second RA type or a second preamble group), uplink control transmission (e.g., PUCCH), or reference signal transmission (e.g., DMRS or SRS). The UE may perform the first transmission with the smallest power value of the set at the second timing, if/when the UE is capable to perform the first transmission with the smallest power value of the set at the second timing.

Preferably in certain embodiments, if/when the UE is capable to perform the first transmission with a largest power value of the set, the UE may perform the first transmission with the largest power value of the set at the first timing. Preferably in certain embodiments, the largest power value may be a maximum UE transmit power. Preferably and/or alternatively in certain embodiments, if/when the UE is capable to perform the first transmission with a maximum UE transmit power, the UE may perform the first transmission with the maximum UE transmit power at the first timing. The set may or may not comprise the maximum UE transmit power.

For instance, the set of predefined/specified/(pre-)configured power values comprise −30 dBm, −25 dBm, −20 dBm, −15 dBm, −10 dBm, −5 dBm, and 0 dBm. If the UE is not capable to perform the first transmission with −30 dBm, the UE may skip or delay/suspend the first transmission at the first timing until the UE is capable to perform the first transmission with −30 dBm at the second timing. If the UE is capable to perform the first transmission with ≥0 dBm, the UE may perform the first transmission with 0 dBm at the first timing. If the UE is capable to perform the first transmission with −10 dBm and the UE is not capable to perform the first transmission with −5 dBm, the UE may perform the first transmission with −10 dBm at the first timing.

Preferably in certain embodiments, the set of predefined/specified/(pre-)configured power values may be the same or different for different types/kinds of the first transmission. The UE may determine/derive the first transmit power based on corresponding set of predefined/specified/(pre-)configured power values, based on the type/kind of the first transmission. The types/kinds of the first transmission may comprise any of preamble transmission (e.g., PRACH, preferably type/kind of PRACH may comprise RA type and/or preamble group), uplink data transmission (e.g., PUSCH), uplink control transmission (e.g., PUCCH), sidelink data transmission (e.g., PSSCH), access transmission (e.g., MSGA), or reference signal transmission (e.g., DMRS or SRS). The types/kinds of the first transmission may comprise data type if the first transmission comprises data. The types/kinds of the first transmission may comprise data size (e.g., larger or smaller than a data size threshold) if the first transmission comprises data. Preferably in certain embodiments, the set of predefined/specified/(pre-)configured power values may be the same or different for different UE types of the UE. The UE may determine/derive the first transmit power with corresponding set of predefined/specified/(pre-)configured power values based on the UE type of the UE.

In one embodiment A3, the UE may determine/derive the first transmit power based on a received carrier wave (signal). Preferably in certain embodiments, the UE may determine/derive the first transmit power based on a received power value (e.g., RSRP) of the received carrier wave (signal). Preferably in certain embodiments, the UE may determine/derive the first transmit power based on a power offset and the received power value of the received carrier wave (signal). Preferably in certain embodiments, the UE may determine/derive the first transmit power as “the received power value of the received carrier wave (signal)” minus “the power offset” (subtraction in dB or in numerical/numeric value). Preferably in certain embodiments, the UE may determine/derive the first transmit power as “the received power value of the received carrier wave (signal)” minus “the power offset” minus “other parameters” (subtraction in dB or in numerical/numeric value). Preferably in certain embodiments, the power offset may be predefined, specified, or (pre-)configured. Preferably in certain embodiments, the power offset may be determined/derived based on the UE capability.

Preferably in certain embodiments, the power offset may be the same or different for different types/kinds of the first transmission. The UE may determine/derive the first transmit power based on the corresponding power offset, based on the type/kind of the first transmission. The types/kinds of the first transmission may comprise any of preamble transmission (e.g., PRACH, preferably type/kind of PRACH may comprise RA type and/or preamble group), uplink data transmission (e.g., PUSCH), uplink control transmission (e.g., PUCCH), sidelink data transmission (e.g., PSSCH), access transmission (e.g., MSGA), or reference signal transmission (e.g., DMRS or SRS). The types/kinds of the first transmission may comprise a data type if the first transmission comprises data. The types/kinds of the first transmission may comprise a data size (e.g., larger or smaller than a data size threshold) if the first transmission comprises data. Preferably in certain embodiments, the power offset may be the same or different for different UE types of the UE. The UE may determine/derive the first transmit power with corresponding power offset based on the UE type of the UE.

In the above embodiments or alternatively, the UE may determine/derive the first transmit power based on at least one of a first maximum UE transmit power (according to the UE capability), a second maximum UE transmit power (allowed by the network or allowed in the cell), and/or a remaining power in UE energy storage. For example, the first transmit power may be a min (the first maximum UE transmit power, the second maximum UE transmit power). For example, the first transmit power may be a min (the first maximum UE transmit power, remaining power in UE energy storage). For example, the first transmit power may be a min (the first maximum UE transmit power, the second maximum UE transmit power, remaining power in UE energy storage).

### Concept B

The concept B is that the UE considers DL/SL pathloss for deriving/determining the first transmit power (e.g., for PRACH and/or PUSCH). The UE may perform pathloss-based power control for deriving/determining the first transmit power.

In one embodiment B1, the UE may determine/derive a pathloss based on received power value (e.g., RSRP) of the received carrier wave (signal). Preferably in certain embodiments, the UE may determine/derive the first transmit power based on the determined/derived pathloss. Preferably in certain embodiments, the UE may determine/derive the first transmit power based on the determined/derived pathloss and a pathloss compensation factor.

Preferably in certain embodiments, the pathloss compensation factor may be predefined/specified/(pre-)configured.

Preferably in certain embodiments, the pathloss compensation factor may be derived/determined based on the repetition factor. Preferably in certain embodiments, the repetition factor may be derived/determined based on the pathloss compensation factor. Preferably in certain embodiments, there may be a mapping or association between the repetition factor and the pathloss compensation factor. Preferably in certain embodiments, a larger value of the repetition factor may correspond to a smaller value of the path compensation factor. A smaller value of the repetition factor may correspond to a larger value of the path compensation factor. Preferably in certain embodiments, the UE may determine/derive the repetition factor based on the determined/derived pathloss. Preferably in certain embodiments, a larger value of the determined/derived pathloss may correspond to a larger value of the repetition factor. A smaller value of the determined/derived pathloss repetition factor may correspond to a smaller value of the repetition factor.

Preferably in certain embodiments, the pathloss compensation factor may be the same or different for different types/kinds of the first transmission. The UE may determine/derive the first transmit power based on the corresponding pathloss compensation factor, based on the type/kind of the first transmission. The types/kinds of the first transmission may comprise any of preamble transmission (e.g., PRACH, preferably type/kind of PRACH may comprise RA type and/or preamble group), uplink data transmission (e.g., PUSCH), uplink control transmission (e.g., PUCCH), sidelink data transmission (e.g., PSSCH), access transmission (e.g., MSGA), or reference signal transmission (e.g., DMRS or SRS). The types/kinds of the first transmission may comprise a data type if the first transmission comprises data. The types/kinds of the first transmission may comprise a data size (e.g., larger or smaller than a data size threshold) if the first transmission comprises data. Preferably in certain embodiments, the pathloss compensation factor may be the same or different for different UE types of the UE. The UE may determine/derive the first transmit power with corresponding pathloss compensation factor based on the UE type of the UE.

In one embodiment B2, the UE may determine/derive a pathloss based on a received power value (e.g., RSRP) of the received carrier wave (signal). Preferably in certain embodiments, the UE may determine/derive the first transmit power with a first power value of a set of predefined/specified/(pre-)configured power values based on the pathloss. Preferably in certain embodiments, a/each power value in the set may be associated with or correspond to a pathloss value range. Different power values in the set may be associated with or correspond to different/exclusive/independent pathloss value ranges. Preferably in certain embodiments, the UE may determine/derive the first transmit power with the first power value of the set of predefined/specified/(pre-)configured power values based on the determined/derived pathloss being in a first pathloss value range associated with the first power value in the set.

Preferably and/or alternatively in certain embodiments, the UE may determine/derive the first transmit power with a first power value of a set of predefined/specified/(pre-)configured power values based on the received power value of the received carrier wave (signal) (it may mean that the UE does not need to determine/derive the pathloss). Preferably in certain embodiments, a/each power value in the set may be associated with or correspond to a received power value range. Different power values in the set may be associated with or correspond to different/exclusive/independent received power value ranges. Preferably in certain embodiments, the UE may determine/derive the first transmit power with the first power value of the set of predefined/specified/(pre-)configured power values based on the received power value being in a first received power value range associated with the first power value in the set.

Preferably in certain embodiments, the set of predefined/specified/(pre-)configured power values are quantified power values for the UE to perform the first transmission. Preferably in certain embodiments, a power value of the set may correspond to a (distance) range, e.g., (distance) range from the carrier wave transmitter.

Preferably in certain embodiments, association between the set of predefined/specified/(pre-)configured power values and the pathloss may be the same or different for different types/kinds of the first transmission. Preferably in certain embodiments, association between the set of predefined/specified/(pre-)configured power values and the received power value may be the same or different for different types/kinds of the first transmission. Preferably in certain embodiments, the set of predefined/specified/(pre-)configured power values may be the same or different for different types/kinds of the first transmission. The UE may determine/derive the first transmit power based on a corresponding set of predefined/specified/(pre-)configured power values, based on the type/kind of the first transmission. The types/kinds of the first transmission may comprise any of preamble transmission (e.g., PRACH, preferably type/kind of PRACH may comprise RA type and/or preamble group), uplink data transmission (e.g., PUSCH), uplink control transmission (e.g., PUCCH), sidelink data transmission (e.g., PSSCH), access transmission (e.g., MSGA), or reference signal transmission (e.g., DMRS or SRS). The types/kinds of the first transmission may comprise a data type if the first transmission comprises data. The types/kinds of the first transmission may comprise a data size (e.g., larger or smaller than a data size threshold) if the first transmission comprises data. Preferably in certain embodiments, the association between the set of predefined/specified/(pre-)configured power values and the pathloss may be the same or different for different UE types of the UE. Preferably in certain embodiments, the association between the set of predefined/specified/(pre-)configured power values and the received power value may be the same or different for different UE types of the UE. Preferably in certain embodiments, the set of predefined/specified/(pre-)configured power values may be the same or different for different UE types of the UE. The UE may determine/derive the first transmit power with a corresponding set of predefined/specified/(pre-)configured power values based on the UE type of the UE.

For any of embodiment B1 or B2, if/when the UE is not capable to perform the first transmission with the determined/derived first transmit power at the first timing, the UE may skip or delay/suspend the first transmission at the first timing until the UE is capable to perform the first transmission with the determined/derived first transmit power at a second timing. The second timing is later than the first timing. Preferably in certain embodiments, the second timing may be with the carrier wave time duration or associated with the carrier wave time duration. The first transmission may be any of preamble transmission (e.g., PRACH), uplink data transmission (e.g., PUSCH), uplink control transmission (e.g., PUCCH), sidelink data transmission (e.g., PSSCH), access transmission (e.g., MSGA), or reference signal transmission (e.g., DMRS or SRS).

Preferably or alternatively in certain embodiments, if/when the UE is not capable to perform the first transmission with the determined/derived first transmit power at the first timing, the UE may perform a second transmission with a second transmit power at the first timing, wherein the second transmit power value is smaller than the determined/derived first transmit power. Preferably in certain embodiments, the second transmit power may be determined/derived based on concept A or concept B. Preferably in certain embodiments, the second transmission may be to notify/inform/report the power insufficient status of the UE or reporting/accessing delay/suspend of the UE. The first transmission may be any of preamble transmission (e.g., PRACH of a first RA type or a first preamble group), uplink data transmission (e.g., PUSCH), uplink control transmission (e.g., PUCCH), sidelink data transmission (e.g., PSSCH), or access transmission (e.g., MSGA). The second transmission may be any of preamble transmission (e.g., PRACH of a second RA type or a second preamble group), uplink control transmission (e.g., PUCCH), or reference signal transmission (e.g., DMRS or SRS). The UE may perform the first transmission with the determined/derived first transmit power at the second timing, if/when the UE is capable to perform the first transmission with the determined/derived first transmit power at the second timing.

Preferably in certain embodiments, the UE may determine/check its power capability based on its battery or its power status or received carrier wave (signal) (e.g., RSRP of the received carrier wave (signal)).

### Concept C

A UE may perform a first transmission. The first transmission may be transmitted (or repeated) for a number of times. Preferably in certain embodiments, the UE may determine whether and/or how to perform the number of repeated transmissions based on a power level. Preferably in certain embodiments, the UE may determine the repetition factor based on the power level. Preferably in certain embodiments, the UE may determine to perform the number of repeated transmissions based on the power level (e.g., satisfying one or more condition).

Alternatively, the UE may determine the power level based on the repetition factor and/or number of repeated transmissions. The power level may be the repetition factor multiplied by a peak TX power of the UE, UE transmit power, expected/targeted received power, and/or pathloss (compensation factor).

Preferably in certain embodiments, the UE may determine whether and/or how to perform the number of repeated transmissions based on a UE type of the UE. Preferably in certain embodiments, the UE may determine the repetition factor based on the UE type of the UE. Preferably in certain embodiments, the UE may determine to perform the number of repeated transmissions based on the UE type of the UE.

Preferably in certain embodiments, the UE may determine whether and/or how to perform the number of repeated transmissions based on a type of the first transmission. Preferably in certain embodiments, the UE may determine the repetition factor based on the type of the first transmission. Preferably in certain embodiments, the UE may determine to perform the number of repeated transmissions based on the type of the first transmission.

The concept C may comprise any one or more of the following embodiments:

In one embodiment C1, the power level may be (or include) a received power of a signal/channel transmitted from the network node.

In one embodiment C2, the power level may be (or include) a (downlink) pathloss derived/determined based on at least the received power of the signal/channel transmitted from the network node.

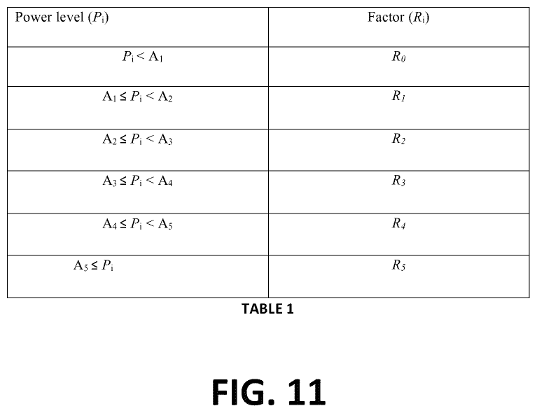

In one embodiment C3, the power level may be (or include) an expected/derived/determined UE transmit power for the first transmission (e.g., based on any embodiment(s) of concept A and/or B). Preferably in certain embodiments, the UE may determine to perform the number of repeated transmissions based on the expected/derived/determined UE transmit power smaller than a transmit power threshold. The UE may determine to perform one-shot transmissions based on the expected/derived/determined UE transmit power larger than the transmit power threshold. Preferably in certain embodiments, the UE may determine the repetition factor based on the expected/derived/determined UE transmit power. Preferably in certain embodiments, a larger value of the expected/derived/determined UE transmit power may correspond to a smaller value of the repetition factor. A smaller value of the expected/derived/determined UE transmit power may correspond to a larger value of the repetition factor. For an instance as shown in Table 1 of FIG. 11, the power level Pᵢ is the expected/derived/determined UE transmit power. A₁<A₂<A₃<A₄<A₅ and R₅≤R₄≤R₃≤R₂≤R₁. R₀ may be larger than R₁ or mean skip or delay/suspend transmission. R₅ may be 1 (e.g., 1 may correspond to one-shot transmission) or larger than 1. If the expected/derived/determined UE transmit power is A₂≤Pᵢ<A₃, the UE may determine the repetition factor as a value of R₂. The value of A₁˜A₅ and R₀˜R₅ may be predefined/specified/(pre-)configured or determined based on formula or derivation.

In one embodiment C4, the power level may be (or include) a maximum UE transmit power. The maximum UE transmit power may be determined/derived based on the UE type of the UE. The maximum UE transmit power may be determined/derived based on the type of the first transmission (e.g., the first transmission is a backscattering transmission or a transmission generated internally by the UE). Preferably in certain embodiments, the UE may determine to perform the number of repeated transmissions based on the maximum UE transmit power smaller than a transmit power threshold. The UE may determine to perform one-shot transmissions based on the maximum UE transmit power larger than the transmit power threshold. Preferably in certain embodiments, the UE may determine the repetition factor based on the maximum UE transmit power. Preferably in certain embodiments, a larger value of the maximum UE transmit power may correspond to a smaller value of the repetition factor. A smaller value of the maximum UE transmit power may correspond to a larger value of the repetition factor.

In one embodiment C5, the power level may be (or include) an amount of the UE's battery power/stored power/available power. The UE may estimate/determine/derive how much the battery power/stored power/available power are utilizable/available for performing the first transmission or the repeated transmissions or a procedure associated with the first transmission. Preferably in certain embodiments, the UE may determine to perform the number of repeated transmissions based on the amount of the UE's battery power/stored power/available power larger than a power threshold. The UE may determine to perform one-shot transmissions based on the amount of the UE's battery power/stored power/available power smaller than the power threshold. Preferably in certain embodiments, the UE may determine the repetition factor based on the amount of the UE's battery power/stored power/available power. Preferably in certain embodiments, a larger value of the amount of the UE's battery power/stored power/available power may correspond to a larger value of the repetition factor. A smaller value of the amount of the UE's battery power/stored power/available power may correspond to a smaller value of the repetition factor. For an instance as shown in Table 1 of FIG. 11, the power level Pᵢ is the amount of the UE's battery power/stored power/available power. A₁<A₂<A₃<A₄<A₅ and R₀≤R₁≤R₂≤R₃≤R₄≤R₅. R₀ may be 1 (e.g., 1 may correspond to one-shot transmission) or larger than 1. If the derived/determined pathloss is A₂≤Pᵢ<A₃, the UE may determine the repetition factor as a value of R₂. The value of A₁˜A₅ and R₀˜R₅ may be predefined/specified/(pre-)configured or determined based on formula or derivation.

In one embodiment C6, the power level may be (or include) a predefined/(pre-)configured/indicated power. The indicated power can be indicated by the network node or by the higher layer of the UE. Preferably in certain embodiments, the predefined/(pre-)configured/indicated power can be a guaranteed or required power (amount or capacity) for enabling/activating/starting (corresponding) the first transmission or repeated transmission or a procedure associated with the first transmission. Preferably in certain embodiments, the predefined/(pre-)configured/indicated power can be an expected/estimated power consumption (amount) for completing (corresponding) the first transmission or the repeated transmission or the procedure associated with the first transmission. Preferably in certain embodiments, the UE may determine to perform the number of repeated transmissions based on the predefined/(pre-)configured/indicated power larger than a power threshold. The UE may determine to perform one-shot transmissions based on the predefined/(pre-)configured/indicated power smaller than the power threshold. Preferably in certain embodiments, the UE may determine the repetition factor based on the predefined/(pre-)configured/indicated power.

In one embodiment C7, the power level may be (or include) a power difference between the (downlink) pathloss and the expected/derived/determined/maximum UE transmit power of the first transmission (e.g., based on any embodiment(s) of concept A and/or B). The (downlink) pathloss may be derived/determined based on at least the received power of the signal/channel, e.g., a carrier wave (signal), from the network. The expected/derived/determined UE transmit power may be for backscattering transmission or for UL transmission generated internally by the UE.

In one embodiment C8, the power level may be (or include) a power difference between the battery power/stored power/available power and the expected/derived/determined/maximum UE transmit power of the first transmission (e.g., based on any embodiment(s) of concept A and/or B). The expected/derived/determined UE transmit power may be for backscattering transmission or for UL transmission generated internally by the UE. The UE may estimate/determine/derive how much the battery power/stored power/available power are utilizable for performing (corresponding) the first transmission or repeated transmission or a procedure associated with the first transmission. Preferably in certain embodiments, the UE may determine to perform the number of repeated transmissions based on the power difference larger than a power threshold. The UE may determine to perform one-shot transmissions based on the power difference smaller than the power threshold. Preferably in certain embodiments, the UE may determine the repetition factor based on the power difference. Preferably in certain embodiments, a larger value of the power difference may correspond to a larger value of the repetition factor. A smaller value of the power difference may correspond to a smaller value of the repetition factor.

In one embodiment C9, the power level may be (or include) a power difference between a predefined/(pre-)configured/indicated power and the expected/derived/determined/maximum UE transmit power of the first transmission (e.g., based on any embodiment(s) of concept A and/or B). The indicated power can be indicated by the network or by the higher layer of the UE. Preferably in certain embodiments, the predefined/(pre-)configured/indicated power can be a guaranteed or required power (amount or capacity) for enabling/activating/starting (corresponding) the first transmission or repeated transmission or a procedure associated with the first transmission. Preferably in certain embodiments, the predefined/(pre-)configured/indicated power can be an expected/estimated power consumption (amount) for completing (corresponding) the first transmission or repeated transmission or a procedure associated with the first transmission.

In one embodiment C10, there may be at least a first UE type and a second UE type. Preferably in certain embodiments, the first UE type may be with lower power capability compared to the second UE type. Preferably in certain embodiments, the first UE type may be with lower peak power consumption (e.g., around 1 μW peak power consumption) compared to the second UE type (e.g., around a few hundred μW peak power consumption). Preferably in certain embodiments, the first UE type may be with neither DL nor UL amplification. The second UE type may be with DL and/or UL amplification. Preferably in certain embodiments, the UE may determine to perform the number of repeated transmissions based on the UE being the first UE type. The UE may determine to perform one-shot transmissions based on the UE being the second UE type. Preferably in certain embodiments, when the UE determine to perform the number of repeated transmissions, the UE may determine the repetition factor based on any of above embodiments.

In one embodiment C11, there may be at least a first type of transmission and a second type of transmission. Preferably in certain embodiments, the first type of transmission may be a backscattering transmission. Preferably in certain embodiments, the second type of transmission may be generated internally by the UE. Preferably in certain embodiments, the first type of transmission may be a backscattering transmission. Preferably in certain embodiments, the second type of transmission may be generated internally by the UE. Preferably in certain embodiments, the first type of transmission may be any of preamble transmission (e.g., PRACH of a first RA type or a first preamble group), uplink data transmission (e.g., PUSCH for transmitting a first type of data or with a first data size), uplink control transmission (e.g., PUCCH for transmitting a first type of control information or with a first control information size), sidelink data transmission (e.g., PSSCH for transmitting a first type of data or with a first data size), access transmission (e.g., MSGA), or reference signal transmission (e.g., DMRS or SRS). The second type of transmission may be any of preamble transmission (e.g., PRACH of a second RA type or a second preamble group), uplink data transmission (e.g., PUSCH for transmitting a second type of data or with a second data size), uplink control transmission (e.g., PUCCH for transmitting a second type of control information or with a second control information size), sidelink data transmission (e.g., PSSCH for transmitting a second type of data or with a second data size), access transmission (e.g., MSGA), or reference signal transmission (e.g., DMRS or SRS). Preferably in certain embodiments, the UE may determine to perform the number of repeated transmissions based on the first transmission being the first type of transmission. The UE may determine to perform one-shot transmissions based on the first transmission being the second type of transmission. Preferably in certain embodiments, when the UE determines to perform the number of repeated transmissions, the UE may determine the repetition factor based on any of the above embodiments.

Furthermore, there may also be some embodiments to determine/derive whether and/or how to perform the number of repeated transmissions.

In one embodiment C12, the UE may acquire or obtain an indication or information of the repetition factor. Preferably in certain embodiments, the UE may receive the indication or information of the repetition factor from a receive channel/signal from the network node. Preferably in certain embodiments, the received channel/signal may be/mean any of carrier wave (signal), paging, downlink control information, PDCCH, PDCCH order, MAC CE, system information, common RRC configuration, or dedicated RRC configuration. Preferably in certain embodiments, the UE may receive the indication or information of the repetition factor from the higher layer of the UE. Preferably in certain embodiments, (the indication or information of) the repetition factor may be predefined or specified for the UE, e.g., for the UE type of the UE. Preferably in certain embodiments, (the indication or information of) the repetition factor may be (pre-)configured.

In one embodiment C13, the UE may acquire or obtain two kinds of resources. Preferably in certain embodiments, a first (kind of) resource is for one-shot transmission. A second (kind of) resource is for repeated transmissions or bundled transmissions. Preferably in certain embodiments, if/when the UE determines to perform the first transmission in the first (kind of) resource, the UE may perform one-shot transmission of the first transmission. Preferably in certain embodiments, if/when the UE determines to perform the first transmission in the second (kind of) resource, the UE may perform the number of repeated transmissions comprising the first transmission. Preferably in certain embodiments, the determination of the first (kind of) resource and the second (kind of) resource may be performed based on any of above embodiments C1˜ C12 for determining to perform the number of repeated transmissions or one-shot transmission.

In one embodiment combining C12 and C3/5/8, the UE may acquire or obtain an indication or information of the repetition factor. Preferably in certain embodiments, the UE may receive the indication or information of the repetition factor from a receive channel/signal from the network node. Preferably in certain embodiments, the received channel/signal may be/mean any of carrier wave (signal), paging, downlink control information, PDCCH, PDCCH order, MAC CE, system information, common RRC configuration, or dedicated RRC configuration. Preferably in certain embodiments, the UE may receive the indication or information of the repetition factor from the higher layer of the UE. Preferably in certain embodiments, (the indication or information of) the repetition factor may be predefined or specified for the UE, e.g., for the UE type of the UE. Preferably in certain embodiments, (the indication or information of) the repetition factor may be (pre-)configured. Preferably in certain embodiments, the UE may perform a number of repeated transmissions (e.g. D2R repetitions for a data packet), wherein the number of repeated transmissions is determined based on the indication or the information of the repetition factor and power level of the UE. Preferably in certain embodiments, the power level may be (or include) any of expected/derived/determined UE transmit power for the first transmission, an amount of the UE's battery power/stored power/available power (e.g., energy/power status), a power difference between the battery power/stored power/available power and the expected/derived/determined/maximum UE transmit power of the first transmission, as described above. The number of repeated transmissions may be smaller than or equal to the repetition factor. Preferably in certain embodiments, the UE may perform the number of repeated transmissions with the same transmit power and/or a different transmit power.

Preferably in certain embodiments, the UE may perform each of the number of repeated transmissions with the same transmit power.

Note that any of the above and herein methods, alternatives, concepts, examples, and embodiments may be combined, in whole or in part, or applied simultaneously or separately.

Preferably in certain embodiments, the UE may determine/derive the first transmit power based on any (or any combination) of the embodiment(s) of concept A and/or B, in response to the type of the first transmission and/or the UE type of the UE. Preferably in certain embodiments, the UE may determine/derive the first transmit power based on different embodiment(s) of concept A and/or B, in response to the different types of the first transmission. Preferably in certain embodiments, the UE may determine/derive the first transmit power based on different embodiment(s) of concept A and/or B, in response to different UE types of the UE. Preferably in certain embodiments, when the first transmission is a first type of transmission, the UE may determine/derive the first transmit power based on one of the embodiment(s) of concept A and/or B. Preferably in certain embodiments, when the first transmission is a second type of transmission, the UE may determine/derive the first transmit power based on another of the embodiment(s) of concept A and/or B.

The carrier wave (signal) duration may be a time duration when the UE could receive a carrier wave (signal). The carrier wave (signal) duration may start from when a (new) carrier wave (signal) is started. The carrier wave (signal) duration may end at when the carrier wave (signal) is stopped. The carrier wave (signal) duration may be detected by the UE or be defined/configured by the NW.

Preferably in certain embodiments, the carrier wave (signal) above may be changed/represented/replaced as a DL signal or a DL channel. Preferably in certain embodiments, the carrier wave (signal) may be changed/represented/replaced as any of PDCCH, or PDSCH, or Synchronization Signal Block (SSB) (e.g., transmitted from a network node or intermediate node). Preferably in certain embodiments, the carrier wave (signal) may be changed/represented/replaced as any of DL DMRS, Channel State Information Reference Signal (CSI-RS), signal for the power source/supply (e.g., transmitted from the network node or intermediate node).

For the UE type, there may be two or more types of UE. The UE types may be differentiated by at least energy storage, method to perform UL transmission, power level, and/or device size. Preferably in certain embodiments, the method to perform UL transmission may be generated internally by the device/UE or be backscattered on the carrier wave (signal) provided externally.

For example, a first type UE may be a device A or device B, e.g., as considered in [2] 3GPP TR 38.848 V18.0.0. The first type UE may have (or be equipped with) battery or energy storage. The first type UE may not have (or be equipped with) battery or energy storage. The first type UE may not have (or be equipped with) DL/UL amplification. The first type UE may be a passive or semi-passive device. The first type UE may generate UL transmission by backscattering. The first type UE may perform backscattering transmission. The first type UE may not be able to generate UL transmission (internally) by itself. The first type UE may not have capability to generate a signal without backscattering.

For example, a second type UE may be a device C, e.g., as considered in [2] 3GPP TR 38.848 V18.0.0. The second type UE may have (or be equipped with) battery or energy storage. The second type UE may have (or be equipped with) DL/UL amplification. The second type UE may be an active device. The second type UE may generate UL transmission by backscattering. The second type UE may perform backscattering transmission. The second type UE may be able to generate UL transmission (internally) by itself. The second type UE may have capability to generate a signal without backscattering.

The RA resources selections (steps) may be performed in any order. A second kind of RA resource selection (step) may depend on a first kind of RA resource selection (step). The RA resources selection(s) (step(s)) may be performed before the first transmission. The RA resources selection(s) (step(s)) may be performed after, when, or in response to initiating or triggering the RA procedure.

In an RA procedure (e.g., for ambient IoT), the UE may not perform UL carrier selection. The UE may not select a UL carrier (e.g., Supplementary Uplink (SUL), Normal Uplink (NUL)). The UE may not be configured with a supplementary uplink. The UE may not evaluate the RSRP of the downlink pathloss reference with an RSRP threshold for SUL (e.g., rsrp-ThresholdSSB-SUL). The UE may not select RA resources based on s UL carrier. Preferably in certain embodiments, the UE may determine a UL carrier based on frequency (e.g., DL carrier or DL frequency band) of a received/detected carrier wave (signal). For instance, the UL carrier is associated with or corresponds to the frequency (e.g., DL carrier or DL frequency band) of the received/detected carrier wave (signal).

In an RA procedure (e.g., for ambient IoT), the UE may not perform SSB selection and/or CSI-RS selection. The UE may not select an SSB/CSI-RS. The UE may not be configured with parameter(s) associated with a beam. The UE may not be (explicitly) provided SSBs and/or CSI-RSs. The UE may not evaluate the Synchronization Signal Reference Signal Received Power (SS-RSRP) with a RSRP threshold for SSB (e.g., rsrp-ThresholdSSB, msgA-RSRP-ThresholdSSB). The UE may not evaluate the CSI-RSRP with an RSRP threshold for CSI-RS (e.g., rsrp-ThresholdCSI-RS). The UE may not select RA resources based on SSB/CSI-RS. Alternatively, RA resource(s)/configuration is (only) allowed to be associated with a specific or same SSB. The UE may (always) select the specific or same SSB.

The above RA resources selections (steps) may be performed based on a first factor. Association(s) between the first factor and RA resource(s) may be indicated or configured by the NW. Alternatively, the association(s) may be determined by the UE. Alternatively, the association(s) may be fixed. Threshold(s) for the first factor may be indicated or configured by the NW. Alternatively, the threshold(s) may be determined by the UE. Alternatively, the threshold(s) may be fixed.

One or more of the above and herein embodiment(s), concept(s), method(s), example(s) or condition(s) could be combined.

The UE may perform BWP selection in an RA procedure, e.g., after or in response to triggering the RA procedure. After or in response to selecting an initial BWP, the UE may perform other kind(s) of RA resource selection(s) (step(s)) (e.g., based on the selected initial BWP) and/or perform the first transmission (e.g., on the selected BWP). When the UE selects a BWP of a cell, the UE may switch (active) BWP of the cell. When the UE selects a BWP of a cell, the UE may deactivate a current BWP and/or activate the selected BWP of the cell. The UE may select a BWP based on the first factor. After the BWP of a cell is selected, the UE does not switch BWP of the cell during the RA procedure. Alternative, the UE is allowed to switch BWP of the cell, e.g., based on the first factor, during the RA procedure.

For example, the UE may select a first BWP of a cell if at least the UE is a first type UE. The UE may select a second BWP of the cell if at least the UE is a second type UE.

For example, the UE may select a BWP based on one or more threshold for power level. The UE may select a first BWP of a cell or a second BWP of the cell based on different power levels. The UE may select a BWP if at least a threshold (for power level) is fulfilled. The UE may not select a BWP if at least the threshold is not fulfilled. The UE may select a BWP once the threshold is fulfilled. The UE may not select a BWP until the threshold is fulfilled. Preferably in certain embodiments, the UE may select a second initial BWP if a second threshold is fulfilled. The UE may select a first initial BWP if the second threshold is not fulfilled and/or if a first threshold is fulfilled.

For example, the UE may select a first BWP of a cell for a first UL data type. The UE may select a second BWP of the cell for a second UL data type.

For example, the UE may select a BWP based on a threshold for UL data size. The UE may select a first BWP of a cell or a second BWP of the cell based on different UL data sizes.

For example, the UE may select a BWP based on (a formula using) its UE ID. The UE may select a first BWP of a cell or a second BWP of the cell based on (a formula using) its UE ID. For example, (UE ID) mod (number of BWP of a cell among which the UE to is select one) could be used to derive or could equal to an (index of) BWP to be selected by the UE.

For example, the UE may select a BWP based on (a formula using) its UE group (ID). The UE may select a first BWP of a cell or a second BWP of the cell based on its UE group (ID). The UE may select a first BWP of a cell or a second BWP of the cell based on a formula using its UE group ID. For example, (UE group ID) mod (number of BWP of a cell among which the UE is to select one) could be used to derive or could equal to an (index of) BWP to be selected by the UE.

For example, the UE may select a BWP based on (a formula using) its UE ID and its UE group (ID).

For example, the UE may select a BWP randomly (with equal probability) from more than one BWP of a cell.

Preferably in certain embodiments, the BWP (in above or below) may be changed/represented/replaced by frequency (sub-) band or frequency resource set.

Throughout the present disclosure, the BWP may be referred to and/or be replaced by an initial BWP.

The RA configuration/resources group may be defined, configured, or selected based on the first factor. The RA configuration/resources group may be associated with a power level, e.g., determined by one or more thresholds. Each power level may be associated with and/or configured with a (separate) RA configuration or a group of RA resources of a cell. The RA configuration group may be associated with a data size level, e.g., determined by one or more thresholds. Each data size level may be associated with and/or configured with a (separate) RA configuration or a group of RA resources of a cell.

The UE may select an RA configuration, RA resources group, and/or RA configuration group, e.g., after or in response to triggering the RA procedure, selecting a BWP, selecting an RA type. After or in response to selecting an RA configuration, the UE may perform other kind(s) of RA resources selection(s) (step(s)) (e.g., based on the selected RA configuration) and/or perform the first transmission (e.g., using the selected RA configuration). The UE may select an RA configuration, RA resources group, and/or RA configuration group of the cell based on the first factor.

For example, the UE may select a first RA configuration of a cell if at least the UE is a first type UE. The UE may select a second RA configuration of the cell if at least the UE is a second type UE.

For example, the UE may select an RA configuration based on one or more thresholds for power level. The UE may select a first RA configuration of a cell or a second RA configuration of the cell based on different power levels. The UE may select a first RA configuration of a cell, a second RA configuration of the cell, or a third RA configuration of the cell based on different power levels. The UE may select an RA configuration if at least a threshold (for power level) is fulfilled. The UE may not select an RA configuration if at least the threshold is not fulfilled. The UE may select an RA configuration once the threshold is fulfilled. The UE may not select an RA configuration until the threshold is fulfilled. Preferably in certain embodiments, the UE may select a second RA configuration if a second threshold is fulfilled. The UE may select a first RA configuration if the second threshold is not fulfilled and/or if a first threshold is fulfilled.

For example, the UE may select a first RA configuration of a cell for a first UL data type. The UE may select a second RA configuration of the cell for a second UL data type.

For example, the UE may select an RA configuration based on a threshold for UL data size. The UE may select a first RA configuration of a cell or a second RA configuration of the cell based on a different UL data size. The UE may select a first RA configuration of a cell, a second RA configuration of the cell, and/or a third RA configuration of the cell based on a different UL data size.

For example, the UE may select an RA configuration based on (a formula using) its UE ID. The UE may select a first RA configuration of a cell or a second RA configuration of the cell based on (a formula using) its UE ID. For example, (UE ID) mod (number of RA configuration of a cell among which the UE is to select one) could be used to derive or could equal to an (index of) RA configuration to be selected by the UE.

For example, the UE may select an RA configuration based on (a formula using) its UE group (ID). The UE may select a first RA configuration of a cell or a second RA configuration of the cell based on its UE group (ID). The UE may select a first RA configuration of a cell or a second RA configuration of the cell based on a formula using its UE group ID. For example, (UE group ID) mod (number of RA configuration of a cell among which the UE is to select one) could be used to derive or could equal to an (index of) BWP to be selected by the UE.

For example, the UE may select an RA configuration based on (a formula using) its UE ID and its UE group (ID).

For example, the UE may select an RA configuration randomly (with equal probability) from multiple RA configurations of a cell.

Throughout the present disclosure, the RA configuration may be referred to and/or be replaced by an RA configuration group, an RA resource(s), and/or an RA resource group.

The UE may be configured with 2-step RA and/or 4-step RA. Alternatively and/or additionally, a cell may include or indicate a 2-step RA configuration and/or 4-step RA configuration (for ambient IoT). The UE may be (always) configured with both a 2-step RA and 4-step RA. The UE may be (always) configured with 2-step RA without 4-step RA. The UE may not use or support 4-step RA. The UE may not be (allowed to) configure a 4-step RA. Alternatively and/or additionally, a cell may not be (allowed to) include or indicate a 4-step RA configuration (for ambient IoT). The UE may perform a 2-step RA for the RA procedure. The 2-step RA may not include the third transmission or the fourth transmission. The UE may perform a 4-step RA for the RA procedure. The 2-step RA may be an RA type with (at least) the first transmission and the second transmission. The 4-step RA may be an RA type with (at least) the first transmission, the second transmission, the third transmission, and the fourth transmission. In a 2-step RA procedure, the UE may transmit UL data/signaling in the first transmission. In a 4-step RA procedure, the UE may not transmit UL data/signaling in the first transmission. In a 4-step RA procedure, the UE may transmit UL data/signaling in the third transmission. The RA type may correspond to, be associated with, and/or be used by (one or more) UE, UE group, UE type, power level, UL data type, and/or UL data size.

The UE may select an RA type, e.g., after or in response to triggering the RA procedure, selecting a BWP, selecting an RA configuration/resources group. After or in response to selecting an RA type, the UE may perform other kind(s) of RA resources selection(s) (step(s)) (e.g., based on the selected RA type) and/or perform the first transmission. The UE may (always) select a 2-step RA. The UE may select an RA type not based on a RSRP of a downlink pathloss reference. The UE may not select an RA type based on the RSRP of the downlink pathloss reference. The UE may not select an RA type based on a RSRP threshold (e.g., msgA-RSRP-Threshold). The UE may select an RA type based on the first factor.

For example, the UE may select a first RA type for a first type UE. The UE may select a second RA type for a second type UE. When/if the UE is a first type UE, the UE may select the first RA type for the first type UE. When/if the UE is a second type UE, the UE may select the second RA type for the second type UE.

For example, the UE may select an RA type based on one or more thresholds for power level. The UE may select a first RA type or a second RA type based on a different power level. The UE may select an RA type if the threshold is fulfilled. The UE may not select an RA type if the threshold is not fulfilled. The UE may select an RA type once the threshold is fulfilled. The UE may not select an RA type until the threshold is fulfilled.

For example, the UE may select a first RA type for a first UL data type. The UE may select a second RA type for a second UL data type.

For example, the UE may select an RA type based on a threshold for a UL data size. The UE may select a first RA type or a second RA type based on a different UL data size.

For example, the UE may select a first RA type or a second RA type based on a formula using its UE ID.

For example, the UE may select a first RA type or a second RA type based on its UE group (ID). The UE may select a first RA type or a second RA type based on a formula using its UE group ID.

In a 2-step RA (procedure), the UE may fallback or switch to a 4-step RA. In a 2-step RA (procedure), the UE may not fallback or switch to a 4-step RA. The UE may switch a 2-step RA to a 4-step RA if, when, or in response to a transmission counter (e.g., PREAMBLE_TRANSMISSION_COUNTER) is above a configured value (e.g., msgA-TransMax) or is equal to the configured value plus 1. The UE may switch a 2-step RA to a 4-step RA if, when, or in response to receiving the second transmission comprising an indication. The indication may be a fallback indication (e.g., fallbackRAR), e.g., in MSGB. The fallback indication may be a MAC sub Protocol Data Unit (subPDU). The UE may switch a 2-step RA to a 4-step RA if, when, or in response to expiry of a response window (e.g., msgB-ResponseWindow) and/or a contention resolution timer (e.g., ra-ContentionResolutionTimer).

For example, the UE may initiate a 2-step RA procedure. The UE may trigger an RA procedure and select the RA type as a 2-step RA. The UE may perform a first transmission (e.g., transmit a MSGA). In response to the first transmission, the UE may start a response window (e.g., msgB-ResponseWindow) and receive a second transmission (e.g., receive a MSGB) when the response window is running. Preferably in certain embodiments, in response to the first transmission, the UE may monitor and/or attempt to receive the second transmission (e.g., receive a MSGB) within a corresponding response window. The UE may receive a fallback indication (e.g., fallbackRAR) in the second transmission (e.g., in MSGB). In response to receiving the fallback indication, the UE may (stop the response window and) perform a third transmission (e.g., transmit a Msg3). In response to the third transmission, the UE may start a contention resolution timer (e.g., ra-ContentionResolutionTimer). The UE may not receive a fourth transmission (e.g., receive a Msg4) when the contention resolution timer is running. If or in response to the contention resolution timer expiring, the UE may set the RA type to 4-step RA, e.g., without checking a transmission counter (e.g., PREAMBLE_TRANSMISSION_COUNTER). The UE may perform an RA resource selection procedure for 4-step RA.

The UE may be configured with one or more RA preamble groups of a cell, e.g., in an RA configuration. The RA preamble group may correspond to, be associated with, and/or be used by (one or more) UEs, UE groups, UE types, power levels, UL data types, and/or UL data sizes. An RA preamble group may include a set of RA preambles or RA preamble indexes.

The UE may perform RA preamble (group) selection in an RA procedure, e.g., after or in response to triggering the RA procedure, selecting a BWP, selecting an RA configuration/resources group, setting an RA type. The UE may select an RA preamble group then (randomly) select an RA preamble (index) among the selected RA preamble group. After or in response to selecting an RA preamble (group), the UE may perform other kind(s) of RA resources selection(s) (step(s)) (e.g., based on the selected RA preamble) and/or perform the first transmission (e.g., using the selected RA preamble). The UE may select an RA preamble based on NW indication, e.g., via SIB, paging, or PDCCH. The UE may select an RA preamble based on the first factor.

For example, the UE may select a first RA preamble (in an RA configuration) of a cell if at least the UE is a first type UE. The UE may select a second RA preamble (in the RA configuration) of the cell if at least the UE is a second type UE.

For example, the UE may select an RA preamble group based on one or more thresholds for power level. The UE may select a first RA preamble group (in an RA configuration) of a cell or a second RA preamble group (in the RA configuration) of the cell based on different power levels. The UE may select a first RA preamble group (in an RA configuration) of a cell, a second RA preamble group (in the RA configuration) of the cell, and/or a third RA preamble group (in the RA configuration) of the cell based on different power levels. The UE may select an RA preamble if at least the threshold is fulfilled. The UE may not select an RA preamble if at least the threshold is not fulfilled. The UE may select an RA preamble once the threshold is fulfilled. The UE may not select an RA preamble until the threshold is fulfilled. Preferably in certain embodiments, the UE may select a second RA preamble if a second threshold is fulfilled. The UE may select a first RA preamble if the second threshold is not fulfilled and/or if a first threshold is fulfilled. For example, the UE may select a first RA preamble (in an RA configuration) of a cell for a first UL data type. The UE may select a second RA preamble (in the RA configuration) of the cell for a second UL data type. The UE may select a third RA preamble group (in the RA configuration) of the cell for a third UL data type.

For example, the UE may select an RA preamble group based on a threshold for a UL data size. The UE may select a first RA preamble group (in an RA configuration) of a cell or a second RA preamble group (in the RA configuration) of the cell based on different UL data sizes. The UE may select a first RA preamble group (in an RA configuration) of a cell, a second RA preamble group (in the RA configuration) of the cell, and/or a third RA preamble group (in the RA configuration) of the cell based on different UL data sizes.

For example, the UE may select an RA preamble based on (a formula using) its UE ID. The UE may select a first RA preamble (in an RA configuration) of a cell or a second RA preamble (in the RA configuration) of the cell based on (a formula using) its UE ID. The UE may select a first RA preamble (in an RA configuration) of a cell, a second RA preamble (in the RA configuration) of the cell, and/or a third RA preamble (in the RA configuration) of the cell based on (a formula using) its UE ID. For example, (UE ID) mod (number of RA preamble groups (in an RA configuration) of a cell among which the UE is to select one) could be used to derive or could equal to an (index of) RA preamble group to be selected by the UE. For example, (UE ID) mod (number of RA preamble indexes (in an RA preamble group) (in an RA configuration) of a cell among which the UE is to select one) could be used to derive or could equal to an (index of) RA preamble index to be selected by the UE.

For example, the UE may select an RA preamble based on (a formula using) its UE group (ID). The UE may select a first RA preamble (in an RA configuration) of a cell or a second RA preamble (in the RA configuration) of the cell based on its UE group (ID). The UE may select a first RA preamble (in an RA configuration) of a cell, a second RA preamble (in the RA configuration) of the cell, and/or a third RA preamble (in the RA configuration) of the cell based on its UE group (ID). The UE may select a first RA preamble (in an RA configuration) of a cell or a second RA preamble (in the RA configuration) of the cell based on a formula using its UE group ID. The UE may select a first RA preamble (in an RA configuration) of a cell, a second RA preamble (in the RA configuration) of the cell, and/or a third RA preamble (in the RA configuration) of the cell based on a formula using its UE group ID. For example, (UE group ID) mod (number of RA preamble group (in an RA configuration) of a cell among which the UE is to select one) could be used to derive or could equal to an (index of) RA preamble group to be selected by the UE. For example, (UE group ID) mod (number of RA preamble index (in an RA preamble group) (in an RA configuration) of a cell among which the UE is to select one) could be used to derive or could equal to an (index of) RA preamble index to be selected by the UE.

For example, the UE may select an RA preamble based on (a formula using) its UE ID and its UE group (ID).

For example, the UE may select an RA preamble group randomly (with equal probability) from more than one RA preamble group (in an RA configuration) of a cell.

For example, the UE may select an RA preamble index randomly (with equal probability) from more than one RA preamble index (in an RA preamble group) (in an RA configuration) of a cell.

Throughout the present disclosure, the RA preamble may be referred to and/or be replaced by an RA preamble group and/or RA preamble index.

The number of RA preamble(s) may be different in each RA preamble group.

The UE may use an RA preamble group with more RA preambles if it has lower power, e.g., based on power level. The UE may use an RA preamble group with more RA preambles if it has higher power, e.g., based on power level. The UE may use an RA preamble group with more RA preambles if it has more critical data, e.g., based on data type. The UE may use an RA preamble group with more RA preambles if it has less available data, e.g., based on UL data size. The UE may use an RA preamble group with more RA preambles if it has more available data, e.g., based on UL data size. The UE may use an RA preamble group with more RA preambles if it is in a UE group with more UEs, e.g., based on UE group ID.

The UE may use an RA preamble group with less RA preambles if it has higher power, e.g., based on power level. The UE may use an RA preamble group with less RA preambles if it has lower power, e.g., based on power level. The UE may use an RA preamble group with less RA preambles if it has less critical data, e.g., based on data type. The UE may use an RA preamble group with less RA preambles if it has less available data, e.g., based on UL data size. The UE may use an RA preamble group with less RA preambles if it has more available data, e.g., based on UL data size. The UE may use an RA preamble group with less RA preambles if it is in a UE group with less UEs, e.g., based on UE group ID.

The RACH occasions (ROs) and/or PUSCH occasion(s) may be configured/included in an RA configuration (of a cell). The RACH occasion(s) and/or PUSCH occasion(s) may correspond to, be associated with, and/or be used by (one or more) UEs, UE groups, UE types, power levels, UL data types, and/or UL data sizes. The RACH occasion(s) may be a time/frequency resource for a RACH transmission. The PUSCH occasion(s) may be a time/frequency resource for a PUSCH transmission.

The UE may perform RO and/or PUSCH occasion(s) selection in an RA procedure, e.g., after or in response to triggering the RA procedure, selecting a BWP, selecting an RA configuration/resources group, setting an RA type, selecting an RA preamble, selecting RO(s). After or in response to selecting RO(s) and/or PUSCH occasion(s), the UE may perform other kind(s) of RA resources selection(s) (step(s)) (e.g., based on the selected RO(s) and/or PUSCH occasion(s)) and/or perform the first transmission (e.g., using the selected RO(s) and/or PUSCH occasion(s)). The UE may select RO(s) and/or PUSCH occasion(s) based on and/or associated with the selected RA preamble. The UE may select the closest RO(s) and/or PUSCH occasion(s) based on and/or associated with the selected RA resources/configuration. The UE may (randomly) select RO(s) and/or PUSCH occasion(s) among the closest N RO(s) and/or PUSCH occasion(s) based on and/or associated with the selected RA resources/configuration. N may be indicated or configured by NW. Alternatively, N may be determined by the UE. Alternatively, N may be fixed. N may be related to the number of the UE group. N may be an integer and/or larger than 1 (or 2 or 3). The UE may select RO(s) and/or PUSCH occasion(s) based on the first factor.

For example, the UE may select a first RO(s) and/or PUSCH occasion(s) (in an RA configuration) of a cell if at least the UE is a first type UE. The UE may select a second RO(s) and/or PUSCH occasion(s) (in the RA configuration) of the cell if at least the UE is a second type UE.

For example, the UE may select RO(s) and/or PUSCH occasion(s) based on one or more thresholds for power level. The UE may select first RO(s) and/or PUSCH occasion(s) (in an RA configuration) of a cell or second RO(s) and/or PUSCH occasion(s) (in the RA configuration) of the cell based on different power levels. The UE may select first RO(s) and/or PUSCH occasion(s) (in an RA configuration) of a cell, second RO(s), and/or PUSCH occasion(s) (in the RA configuration) of the cell and/or third RO(s) and/or PUSCH occasion(s) (in the RA configuration) of the cell based on different power levels. The UE may select RO(s) and/or PUSCH occasion(s) if at least the threshold is fulfilled. The UE may not select RO(s) and/or PUSCH occasion(s) if at least the threshold is not fulfilled. The UE may select RO(s) and/or PUSCH occasion(s) once the threshold is fulfilled. The UE may not select RO(s) and/or PUSCH occasion(s) until the threshold is fulfilled. Preferably in certain embodiments, the UE may select second RO(s) and/or PUSCH occasion(s) if a second threshold is fulfilled. The UE may select first RO(s) and/or PUSCH occasion(s) if the second threshold is not fulfilled and/or if a first threshold is fulfilled.

For example, the UE may select first RO(s) and/or PUSCH occasion(s) (in an RA configuration) of a cell for a first UL data type. The UE may select second RO(s) and/or PUSCH occasion(s) (in the RA configuration) of the cell for a second UL data type. The UE may select third RO(s) and/or PUSCH occasion(s) (in the RA configuration) of the cell for a third UL data type.

For example, the UE may select RO(s) and/or PUSCH occasion(s) based on a threshold for UL data size. The UE may select first RO(s) and/or PUSCH occasion(s) (in an RA configuration) of a cell or second RO(s) and/or PUSCH occasion(s) (in the RA configuration) of the cell based on different UL data sizes. The UE may select first RO(s) and/or PUSCH occasion(s) (in an RA configuration) of a cell, second RO(s) and/or PUSCH occasion(s) (in the RA configuration) of the cell and/or third RO(s) and/or PUSCH occasion(s) (in the RA configuration) of the cell based on different UL data sizes.

For example, the UE may select RO(s) and/or PUSCH occasion(s) based on (a formula using) its UE ID. The UE may select first RO(s) and/or PUSCH occasion(s) (in an RA configuration) of a cell or second RO(s) and/or PUSCH occasion(s) (in the RA configuration) of the cell based on (a formula using) its UE ID. The UE may select first RO(s) and/or PUSCH occasion(s) (in an RA configuration) of a cell, second RO(s), and/or PUSCH occasion(s) (in the RA configuration) of the cell and/or third RO(s) and/or PUSCH occasion(s) (in the RA configuration) of the cell based on (a formula using) its UE ID. For example, (UE ID) mod (number of RO(s) and/or PUSCH occasion(s) (in an RA configuration) of a cell among which the UE is to select one) could be used to derive or could equal to an (index of) RO and/or PUSCH occasion to be selected by the UE.

For example, the UE may select RO(s) and/or PUSCH occasion(s) based on (a formula using) its UE group (ID). The UE may select first RO(s) and/or PUSCH occasion(s) (in an RA configuration) of a cell or second RO(s) (in the RA configuration) of the cell based on (a formula using) its UE group (ID). The UE may select first RO(s) and/or PUSCH occasion(s) (in an RA configuration) of a cell, second RO(s), and/or PUSCH occasion(s) (in the RA configuration) of the cell and/or third RO(s) and/or PUSCH occasion(s) (in the RA configuration) of the cell based on (a formula using) its UE group (ID). For example, (UE group ID) mod (number of RO(s) and/or PUSCH occasion(s) (in an RA configuration) of a cell among which the UE is to select one) could be used to derive or could equal to an (index of) RO and/or PUSCH occasion to be selected by the UE.

For example, the UE may select RO(s) and/or PUSCH occasion(s) based on (a formula using) its UE ID and its UE group (ID).

For example, the UE may select RO(s) and/or PUSCH occasion(s) randomly (with equal probability) from (a number of) ROs and/or PUSCH occasion(s) (in an RA configuration) of a cell.

In an RA procedure, the UE may fallback or switch an RA resources (selection), as mentioned above. The UE may fallback or switch an RA resources (selection) if, when, or in response to a transmission counter (e.g., PREAMBLE_TRANSMISSION_COUNTER) is above or is equal to the configured value, receiving the second transmission or a fourth transmission comprising an indication, and/or expiry of a response window (e.g., msgB-ResponseWindow, ra-ResponseWindow) and/or a contention resolution timer (e.g., ra-ContentionResolutionTimer). The UE may select another RA resources and/or perform another RA resources selection (step).

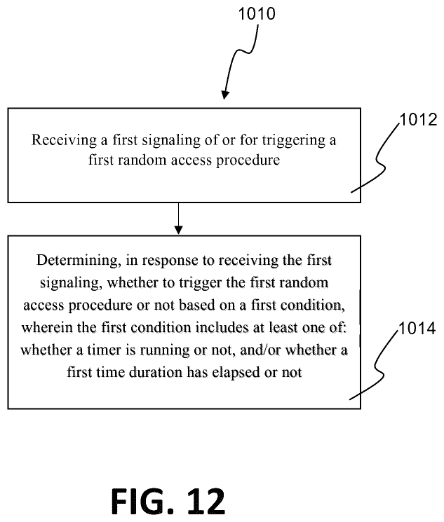

Referring to FIG. 12, with this and other concepts, systems, and methods of the present invention, a method 1010 for a UE in a wireless communication system comprises receiving a first signaling of or for triggering a first random access procedure (step 1012), and determining, in response to (receiving) the first signaling, whether to trigger the first random access procedure or not based on a first condition, wherein the first condition includes at least one of: whether a timer is running or not, and/or whether a first time duration has elapsed or not (step 1014).

In various embodiments, the first signaling is a paging for ambient IoT or a paging message, and/or wherein the first random access procedure is an ambient IoT random access procedure.

In various embodiments, the first signaling indicates an ID of the UE, a group ID of the UE, and/or a set of UEs including the UE, and/or the first signaling is transmitted from a reader, wherein the reader is a network node, an intermediate node, or another UE.

In various embodiments, the first signaling indicates a value of the timer or a time length of the first time duration, and/or wherein the timer is a prohibit timer or a random access prohibit timer.

In various embodiments, the method further comprises receiving a second signaling of or for triggering a second random access procedure before receiving the first signaling, and triggering or performing the second random access procedure in response to receiving the second signaling, wherein the second random access procedure is triggered, performed, and/or started before the first random access procedure.

In various embodiments, the second signaling indicates a value of the timer or a time length of the first time duration, and/or wherein the second signaling is a paging for ambient IoT or a paging message.

In various embodiments, the method further comprises starting the timer and/or the first time duration when the UE receives the second signaling, when the UE triggers the second random access procedure, when the UE performs a transmission in the second random access procedure, and/or when the second random access procedure is completed.

In various embodiments, the first signaling and the second signaling indicate a same target ID corresponding to or including the UE. In various embodiments, the first signaling and the second signaling indicate a same request or a same service, wherein the service is a command or inventory.

In various embodiments, the method further comprises not triggering the first random access procedure if (at least) the timer is running or if (at least) the determination is performed during the first time duration, and/or triggering the first random access procedure if (at least) the timer is not running or if (at least) the determination is performed after the first time duration or the first time duration has elapsed.

In various embodiments, the first condition includes that the UE receives a configuration related to data transmission or reception.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling of or for triggering a first random access procedure; and (ii) determine, in response to (receiving) the first signaling, whether to trigger the first random access procedure or not based on a first condition, wherein the first condition includes at least one of: whether a timer is running or not, and/or whether a first time duration has elapsed or not. Moreover, the CPU 308 can execute the program code 312 to perform all of the described actions, steps, and methods described above, below, or otherwise herein.

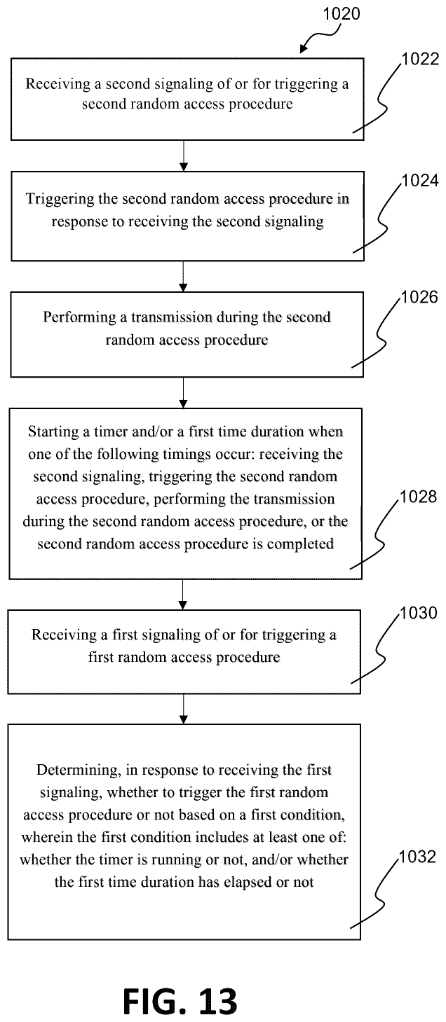

Referring to FIG. 13, with this and other concepts, systems, and methods of the present invention, a method 1020 for a UE in a wireless communication system comprises receiving a second signaling of or for triggering a second random access procedure (step 1022), triggering the second random access procedure in response to receiving the second signaling (step 1024), performing a transmission during the second random access procedure (step 1026), starting a timer and/or a first time duration when one of the following timings occur: receiving the second signaling, triggering the second random access procedure, performing the transmission during the second random access procedure, or the second random access procedure is completed (step 1028), receiving a first signaling of or for triggering a first random access procedure (step 1030), and determining, in response to (receiving) the first signaling, whether to trigger the first random access procedure or not based on a first condition, wherein the first condition includes at least one of: whether the timer is running or not, and/or whether the first time duration has elapsed or not (step 1032).

In various embodiments, the first signaling and the second signaling are paging for ambient IoT or paging messages, and/or wherein the first signaling and/or the second signaling indicates a value of the timer or a time length of the first time duration.

In various embodiments, the first signaling and the second signaling indicate a same ID or a same group ID of the UE, and/or the first signaling and the second signaling indicates a same set of UEs including the UE, and/or the first signaling and the second signaling indicate a same target ID corresponding to or including the UE, and/or the first signaling and the second signaling indicate a same request or a same service.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a second signaling of or for triggering a second random access procedure; (ii) trigger the second random access procedure in response to receiving the second signaling; (iii) perform a transmission during the second random access procedure; (iv) start a timer and/or a first time duration when one of the following timings occur: receiving the second signaling, triggering the second random access procedure, performing the transmission during the second random access procedure, or the second random access procedure is completed; (v) receive a first signaling of or for triggering a first random access procedure; and (vi) determine, in response to (receiving) the first signaling, whether to trigger the first random access procedure or not based on a first condition, wherein the first condition includes at least one of: whether the timer is running or not, and/or whether the first time duration has elapsed or not. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a first signaling of or for triggering a first random access procedure; and
determining, in response to receiving the first signaling, whether to trigger the first random access procedure or not based on a first condition, wherein the first condition includes at least one of:
whether a timer is running or not; and/or
whether a first time duration has elapsed or not.

2. The method of claim 1, wherein the first signaling is a paging for ambient Internet of Things (IoT) or a paging message, and/or wherein the first random access procedure is an ambient IoT random access procedure.

3. The method of claim 1, wherein:
the first signaling indicates an Identity (ID) of the UE, a group ID of the UE, and/or a set of UEs including the UE, and/or
the first signaling is transmitted from a reader, wherein the reader is a network node, an intermediate node, or another UE.

4. The method of claim 1, wherein the first signaling indicates a value of the timer or a time length of the first time duration, and/or wherein the timer is a prohibit timer or a random access prohibit timer.

5. The method of claim 1, further comprising:
receiving a second signaling of or for triggering a second random access procedure before receiving the first signaling; and
triggering or performing the second random access procedure in response to receiving the second signaling, wherein the second random access procedure is triggered, performed, and/or started before the first random access procedure.

6. The method of claim 5, wherein the second signaling indicates a value of the timer or a time length of the first time duration, and/or wherein the second signaling is a paging for ambient IoT or a paging message.

7. The method of claim 5, further comprising starting the timer and/or the first time duration when the UE receives the second signaling, the UE triggers the second random access procedure, the UE performs a transmission in the second random access procedure, and/or the second random access procedure is completed.

8. The method of claim 5, wherein the first signaling and the second signaling indicate a same target ID corresponding to or including the UE, and/or wherein the first signaling and the second signaling indicate a same request or a same service, wherein the service is a command or inventory.

9. The method of claim 1, further comprising:
not triggering the first random access procedure if at least the timer is running or if at least the determination is performed during the first time duration; and/or
triggering the first random access procedure if at least the timer is not running or if at least the determination is performed after the first time duration or the first time duration has elapsed.

10. The method of claim 1, wherein the first condition includes that the UE receives a configuration related to data transmission or reception.

11. A method of a User Equipment (UE), comprising:
receiving a second signaling of or for triggering a second random access procedure;
triggering the second random access procedure in response to receiving the second signaling;
performing a transmission during the second random access procedure;
starting a timer and/or a first time duration when one of the following timings occur:
receiving the second signaling;
triggering the second random access procedure;
performing the transmission during the second random access procedure; or
the second random access procedure is completed;
receiving a first signaling of or for triggering a first random access procedure; and
determining, in response to receiving the first signaling, whether to trigger the first random access procedure or not based on a first condition, wherein the first condition includes at least one of:
whether the timer is running or not; and/or
whether the first time duration has elapsed or not.

12. The method of claim 11, wherein the first signaling and the second signaling are paging for ambient Internet of Things (IoT) or paging messages, and/or wherein the first signaling and/or the second signaling indicates a value of the timer or a time length of the first time duration.

13. The method of claim 11, wherein:
the first signaling and the second signaling indicate a same Identity (ID) or a same group ID of the UE, and/or
the first signaling and the second signaling indicates a same set of UEs including the UE, and/or
the first signaling and the second signaling indicate a same target ID corresponding to or including the UE, and/or
the first signaling and the second signaling indicate a same request or a same service.

14. A User Equipment (UE), comprising:
a memory; and
a processor operatively coupled with the memory, wherein the processor is configured to execute a program code to:
receive a first signaling of or for triggering a first random access procedure; and
determine, in response to receiving the first signaling, whether to trigger the first random access procedure or not based on a first condition, wherein the first condition includes at least one of:
whether a timer is running or not; and/or
whether a first time duration has elapsed or not.

15. The UE of claim 14, wherein the first signaling is a paging for ambient Internet of Things (IoT) or a paging message, and/or wherein the first random access procedure is an ambient IoT random access procedure.

16. The UE of claim 14, wherein:
the first signaling indicates an Identity (ID) of the UE, a group ID of the UE, and/or a set of UEs including the UE, and/or
the first signaling is transmitted from a reader, wherein the reader is a network node, an intermediate node, or another UE.

17. The UE of claim 14, wherein the first signaling indicates a value of the timer or a time length of the first time duration, and/or wherein the timer is a prohibit timer or a random access prohibit timer.

18. The UE of claim 14, wherein the processor is further configured to execute the program code to:
receive a second signaling of or for triggering a second random access procedure before receiving the first signaling; and
trigger or perform the second random access procedure in response to receiving the second signaling, wherein the second random access procedure is triggered, performed, and/or started before the first random access procedure.

19. The UE of claim 18, wherein the second signaling indicates a value of the timer or a time length of the first time duration, and/or wherein the second signaling is a paging for ambient IoT or a paging message.

20. The UE of claim 18, wherein the processor is further configured to execute the program code to:
start the timer and/or the first time duration when the UE receives the second signaling, the UE triggers the second random access procedure, the UE performs a transmission in the second random access procedure, and/or the second random access procedure is completed.
